(19) United States
(12) Patent Application Publication
(10) Pub. No.: US 2020/0018544 A1
(43) Pub. Date: Jan. 16, 2020

(54) HIGH-PRESSURE DENSITY-DRIVEN SEPARATION

(71) Applicant: The Curators of the University of Missouri, Columbia, MO (US)

(72) Inventors: William Jacoby, Columbia, MO (US); Reza Espanani, Columbia, MO (US)

(73) Assignee: The Curators of the University of Missouri, Columbia, MO (US)

(21) Appl. No.: 16/485,592

(22) PCT Filed: Feb. 14, 2018
(86) PCT No.: PCT/US18/18227

§ 371 Date: Aug. 13, 2019

Related U.S. Application Data
(60) Provisional application No. 62/458,783, filed on Feb. 14, 2017.

(51) Int. Cl. F25J 3/02; C01B 32/50; C01B 21/04; C01B 3/50

(52) U.S. Cl. CPC F25J 3/0266; C01B 32/50; C01B 21/0433; C01B 3/506; F25J 3/0219; F25J 2215/10; C01B 2210/0009; C01B 2203/046; F25J 2205/40; F25J 2215/80; F25J 3/0252

(57) ABSTRACT

In general, the present invention is directed to processes for separating a vapor comprising a first component and a second component using high-pressure density-driven separation. The present invention further relates to various processes for the capture of carbon dioxide. In particular, various processes of the present invention relate to the separation of carbon dioxide from flue gas of combustion processes. The invention also applies to upgrading fuel gases containing carbon dioxide. The invention also applies to separation of hydrogen from fuel gas vapor solutions.

### FIELD OF THE INVENTION

In general, the present invention is directed to processes for separating a vapor comprising a first component and a second component using high-pressure density-driven separation. The present invention further relates to various processes for the capture of carbon dioxide. In particular, various processes of the present invention relate to the separation of carbon dioxide from flue gas of combustion processes. The invention also applies to upgrading fuel gases containing carbon dioxide. The invention also applies to separation of hydrogen from fuel gas vapor solutions.

### BACKGROUND OF THE INVENTION

Global warming is caused by greenhouse gases such as carbon dioxide, and methane. Carbon dioxide makes up about 80% (by mass) of greenhouse gas emitted by human activities. Therefore, carbon dioxide emission plays a significant role in global warming. Carbon dioxide concentration in the atmosphere has increased from 280 ppm at the beginning of the industrial revolution, to over 400 ppm today. The International Panel on Climate Change (IPCC) predicts it will reach 570 ppm by the end of the century. Combustion of coal, oil, and natural gas emits carbon dioxide. Therefore, separation of carbon dioxide from flue gas is an important tool to limit global warming.

### BRIEF SUMMARY OF THE INVENTION

In various aspects, the present invention is directed to processes for separating a vapor comprising a first component and a second component using high-pressure density-driven separation. The processes comprise compressing the vapor to form a compressed mixture wherein the first component has a density that is greater than the density of the second component; feeding the compressed mixture to a high-pressure density-driven separator wherein a stream enriched in the first component and a stream enriched in the second component are formed; removing the stream enriched in the first component from the separator; and removing the stream enriched in the second component from the separator.

Certain processes in accordance with the present invention are directed to the capture of carbon dioxide. These processes comprise: compressing a vapor (e.g., an exhaust gas or flue gas) comprising carbon dioxide and at least one other component to form a compressed mixture comprising a dense carbon dioxide fluid and the at least one other component (which is less dense); feeding the compressed mixture comprising the dense carbon dioxide fluid and the at least one other component to a high-pressure density-driven separator wherein a stream enriched in the dense carbon dioxide fluid (a separand) and a stream enriched in the at least one other component (which is less dense) are formed; removing the stream enriched in the dense carbon dioxide fluid from the separator; and removing the stream enriched in the at least one other component from the separator.

Also, the present invention is directed to various apparatus for separating a vapor comprising two or more components. Some apparatus comprise (a) one or more compressors comprising an inlet for introducing a vapor to the compressor and an outlet for removing a compressed fluid; (b) a high-pressure density-driven separator comprising a vessel, a feed inlet for introducing the compressed fluid to the vessel, a first outlet for removing a stream enriched in a dense fluid from the vessel, and a second outlet for removing the stream enriched a less dense fluid from the vessel, and wherein the feed inlet of the high-pressure density-driven separator is in fluid communication with the outlet of the compressor; and (c) one or more expanders is in fluid communication with the first outlet and/or second outlet of the high-pressure density-driven separator.

Other objects and features will be in part apparent and in part pointed out hereinafter.

### BRIEF DESCRIPTION OF THE DRAWINGS

FIG. 1A. Schematic of process for removal of carbon dioxide from flue gas.

FIG. 1B. Schematic of process for removal of carbon dioxide from flue gas.

FIG. 2. Pxy diagram for the nitrogen/carbon dioxide system. The low liquid mole fraction of nitrogen, designated as x₁, is in equilibrium with a corresponding higher vapor mole fraction of vapor (y₁). Correspondence is along horizontal tie lines. A representative tie line is shown in red dash. At or below 15% carbon dioxide by volume (or at or above 85% nitrogen by volume) as shown in the blue box, only vapor phase exists.

FIG. 3. Fluid density of carbon dioxide as a function of pressure at 25° C. For comparison, the additional components of flue gas (nitrogen and oxygen), as well as representative components of fuel gas (methane, CO, hydrogen) are also shown.

FIG. 4. Schematic diagram of an experimental apparatus: (1) nitrogen tank, (2) carbon dioxide tank, (3) High pressure syringe pumps of nitrogen, (4) High pressure syringe pumps of carbon dioxide, (5) Mixing tee, (6) Check valve, (7) high-pressure density-driven separator, (8) Back-pressure regulators, (9) carbon dioxide detector, (10) Computer, (11) Valves, (12) Pressure indicators, (13) Temperature indicator, (14) Controller of nitrogen pumps, (15) Controller of carbon dioxide pumps, (16) Flowmeter.

FIG. 5. Schematic representation of the first prototype high-pressure density-driven separator (HDS-1). L, the vertical distance between the inlet and the upper outlet port, is a key design parameter. Values for L range from 15 cm to 76 cm.

FIG. 6. Separation metric (S) versus the product of the Archimedes Number and the Espanani Number for HDS-1.

FIG. 7. Schematic of HDS-2, featuring normal and tangential inlet ports. L=122 cm and D=7.5 cm.

FIG. 8. Ratio of the density of carbon dioxide to the density of nitrogen as a function of temperature at 10 MPa (100 bar).

FIG. 9. A schematic of HDS-3. Vapor stream to be treated flow through the inner tube, coolant through the outer annulus.

FIG. 10. Performance metric VEsep evaluated for various prototypes and modes of operation. Please see Table 5 in the text for conditions of the numbered runs.

FIG. 11A. A schematic of HDS-4 featuring multi-pass heat exchange tubes, and (in some experiments) packing in the shell side.

FIG. 11B. A schematic of HDS-4 featuring multi-pass heat exchange tubes, and (in some experiments) packing in the shell side.

FIG. 12. High-pressure density-driven separator featuring recirculation of separand carbon dioxide on the “tube side” while gas being treated flows on the “shell side.” Changes in state (0→1→2) are shown on the P-H diagram (FIG. 13).

FIG. 13. Pressure Enthalpy diagram with one path defined for use of carbon dioxide separand as a heat transfer fluid (coolant).

FIG. 14. Internal recycle of the carbon dioxide separand. Expansion and heat transfer can occur simultaneously in the “tube-side” inside the high-pressure density-driven separator.

FIG. 15A. Increasing surface area on the shell side by using fins (left) or fibrous/porous packing (right).

FIG. 15B. At left spiralized conical packing oriented in two directions. In either orientation, the large horizontal arrow represents the nozzle through which the pressurized gas mixture to be treated is introduced into the inner surface of the spiralized cone. The large vertical arrow pointing up represents the exit port for the less dense components of the gas mixture from the top of the HDS. The dashed line is one of many nano-scale channels for flow of liquid-like CO₂ down the outside of the spiralized cone. The large vertical arrow pointing down represents the exit port for the CO₂ at the bottom of the HDS. At right, top is the acute angle in the spiral channel that promotes surface tension driven flow of liquid-like CO₂ represented by the dashed line. At right, bottom, is a microscopic hole paced periodically in the bottom of the spiral channel to allow CO₂ to wick through and down the outside of the spiralized packing.

FIG. 16. Underground high-pressure density-driven separator directly coupled with deep well injection for geologic sequestration or enhanced recovery.

FIG. 17. A self-sealing cap for high-pressure density-driven separator, open at low pressure, sealed at high pressure.

FIG. 18. Cost of removing one metric ton of carbon dioxide as a function of expansion efficiency and compression efficiency.

### DETAILED DESCRIPTION OF THE INVENTION

In various aspects, the present invention is directed to processes for separating a vapor comprising a first component and a second component using high-pressure density-driven separation. The processes comprise compressing the vapor to form a compressed mixture wherein the first component has a density that is greater than the density of the second component; feeding the compressed mixture to a high-pressure density-driven separator wherein a stream enriched in the first component and a stream enriched in the second component are formed; removing the stream enriched in the first component from the separator; and removing the stream enriched in the second component from the separator.

Certain processes in accordance with the present invention are directed to the capture of carbon dioxide. These processes comprise: compressing a vapor (e.g., an exhaust gas, flue gas, or fuel gas) comprising carbon dioxide and at least one other component to form a compressed mixture comprising a dense carbon dioxide fluid and the at least one other component (which is less dense); feeding the compressed mixture comprising the dense carbon dioxide fluid and the at least one other component to a high-pressure density-driven separator wherein a stream enriched in the dense carbon dioxide fluid (a separand) and a stream enriched in the at least one other component (which is less dense) are formed; removing the stream enriched in the dense carbon dioxide fluid from the separator; and removing the stream enriched in the at least one other component from the separator.

Typically, these processes are continuous processes.

In various embodiments, the vapor has a carbon dioxide concentration of at least about 1%, at least about 5%, or at least about 10% by volume. For example, the vapor can have a carbon dioxide concentration of from about 1% to about 25%, from about 5% to about 25%, from about 10% to about 25%, from about 1% to about 50%, from about 5% to about 50%, or from about 10% to about 50% by volume.

In some embodiments, the at least one other component is selected from the group consisting of nitrogen, oxygen, methane, hydrogen, ethane, propane, carbon monoxide, water, sulfur dioxide, nitrogen dioxide, and mixtures thereof. Typically, the vapor comprises at least two, three, four, or five other components selected from the group consisting of nitrogen, oxygen, methane, hydrogen, ethane, propane, carbon monoxide, water, sulfur dioxide, nitrogen dioxide, and mixtures thereof.

In certain embodiments, the at least one other component comprises nitrogen. In these embodiments, vapor can have a nitrogen concentration of at least about 50%, at least about 60%, at least about 70%, or at least about 80% by volume. In further embodiments, the vapor can have a nitrogen concentration of from about 50% to about 90%, from about 50% to about 85%, from about 50% to about 80%, from about 50% to about 70%, from about 60% to about 90%, from about 60% to about 85%, from about 60% to about 80%, from about 60% to about 70%, from about 70% to about 90%, from about 70% to about 85%, from about 70% to about 80%, from about 80% to about 90%, from about 80% to about 85% or from about 85% to about 90% by volume.

In some embodiments, the vapor comprises hydrogen. In these embodiments, hydrogen can be further separated from the at least one other component (e.g., nitrogen, carbon monoxide, oxygen, methane, etc.).

In various embodiments, the vapor comprises flue gas produced from the combustion of a carbonaceous fuel. In some embodiments, the vapor comprises a fuel gas selected from the group consisting of natural gas, shale gas, town gas, producer gas, and biogas.

In various embodiments, the vapor can be compressed to a pressure of at least about 4 MPa, at least about 8 MPa, at least about 10 MPa, at least about 12 MPa, or at least about 15 MPa. Also, the temperature of the compressed mixture that is fed to the high-pressure density-driven separator can be at least or about 25° C., at least or about 10° C., at least or about 0° C., or at least or about −10° C. In some embodiments, the temperature of the compressed mixture that is fed to the high-pressure density-driven separator is from about −10° C. to about 40° C., from about −10° C. to about 30° C., from about −10° C. to about 25° C., from about 0° C. to about 40° C., from about 0° C. to about 30° C., from about 0° C. to about 25° C., from about 10° C. to about 40° C., or from about 10° C. to about 30° C. In certain embodiments, the dense carbon dioxide fluid has a density that is at least about 0.5 g/cm³ or at least about 0.7 g/cm³ greater than the other components of the gas.

In various embodiments, the thermodynamic state (pressure, temperature, and composition) of the vapor provides for a substantially complete separation of the carbon dioxide from the at least one other component. In some embodiments, the stream enriched in the dense carbon dioxide fluid from the separator comprises at least about 70%, at least about 80%, at least about 90%, at least about 95%, or at least about 99% of the carbon dioxide content of the compressed mixture fed to the high-pressure density-driven separator. For example, the stream enriched in the dense carbon dioxide fluid from the separator comprises from about 70% to about 100%, from about 70% to about 99%, from about 70% to about 95%, from about 70% to about 90%, from about 80% to about 100%, from about 80% to about 99%, from about 80% to about 95%, from about 80% to about 90%, from about 90% to about 100%, from about 90% to about 99%, from about 90% to about 95%, from about 95% to about 100% of the carbon dioxide content of the compressed mixture fed to the high-pressure density-driven separator.

Typically, the stream enriched in the at least one other component from the separator comprises at least about 70%, at least about 80%, at least about 90%, at least about 95%, or at least about 99% of the at least one other component content of the compressed mixture fed to the high-pressure density-driven separator. For example, the stream enriched in the at least one other component from the separator comprises from about 70% to about 100%, from about 70% to about 99%, from about 70% to about 95%, from about 70% to about 90%, from about 80% to about 100%, from about 80% to about 99%, from about 80% to about 95%, from about 80% to about 90%, from about 90% to about 100%, from about 90% to about 99%, from about 90% to about 95%, from about 95% to about 100% of the at least one other component content of the compressed mixture fed to the high-pressure density-driven separator.

In various embodiments, the high-pressure density-driven separator comprises a vessel, a feed inlet for introducing the compressed mixture to the vessel, a first outlet for removing the stream enriched in dense carbon dioxide fluid from the vessel, and a second outlet for removing the stream enriched in the at least one other component from the vessel.

As discussed further herein, the compressed mixture can be subjected to a cyclonic fluid motion in the high-pressure density-driven separator to enhance the rate of separation of the carbon dioxide from the at least one other component. For example, the feed inlet can comprise a nozzle configured to induce cyclonic fluid motion. In certain embodiments, the nozzle has an orientation that is tangential or approximately normal to the direction of fluid flow in the vessel of the high-pressure density-driven separator.

In some embodiments, the vessel of the high-pressure density-driven separator comprises surface internals to induce cyclonic fluid motion. Surface internals can comprise structures of a macroscopic scale, a microscopic scale, and/or nano-scale. Examples of surface internals comprise fins, a porous packing material, and/or a series of capillaries. In certain embodiments, the surface internals further facilitate the formation of liquid-like carbon dioxide and its surface tension-driven flow. In various embodiments, the high-pressure density-driven separator comprises surface internals comprising a spiralized conical packing.

As discussed further herein, the processes of the present invention can include further process steps and features, such as those to increase efficiencies and recover energy from the compressed mixture.

In various embodiments, the processes described herein further comprise cooling of the high-pressure density-driven separator vessel and the fluids, structures and surfaces therein. Further, the high-pressure density-driven separator can further comprise a heat exchanger comprising a tube for flow of a heat transfer fluid (i.e., the heat transfer fluid is not in fluid contact with the compressed mixture that is being separated in the separator).

In various embodiments, the vessel of the high-pressure density-driven separator comprises a heat exchanger in a tube-in-tube configuration wherein the vessel forms an outer tube and a heat transfer fluid flows through an inner tube. In further embodiments, the vessel of the high-pressure density-driven separator comprises a heat exchanger in a tube-in-tube configuration wherein the vessel forms an inner tube and a heat transfer fluid flows through an outer tube. In other embodiments, the vessel of the high-pressure density-driven separator comprises a heat exchanger in a tube-in-shell configuration wherein the vessel forms a shell and a heat transfer fluid flows through a series of enclosed tubes. In some embodiments, the flow of the heat transfer fluid is such that carbon dioxide is preferentially cooled relative to the other component(s) of the vapor.

The processes described herein can further comprise recirculating at least a portion of the dense carbon dioxide fluid removed from the high-pressure density-driven separator as a heat transfer fluid to a tube the heat exchanger. In some embodiments, the dense carbon dioxide fluid that is recirculated undergoes a change of state via heat transfer (e.g., heat transfer to the separator and any surface internals therein).

The processes described herein can also comprise expanding or heating at least a portion of the dense carbon dioxide fluid removed from the high-pressure density-driven separator such that the dense carbon dioxide fluid undergoes a change in state. For example, the dense carbon dioxide fluid can undergo a change in state in an engine or device external to the high-pressure density-driven separator.

As noted, the present invention is further directed to processes for separating a vapor comprising a first component and a second component. The processes comprise compressing the vapor to form a compressed mixture wherein the first component has a density that is greater than the density of the second component; feeding the compressed mixture to a high-pressure density-driven separator wherein a stream enriched in the first component and a stream enriched in the second component are formed; removing the stream enriched in the first component from the separator; and removing the stream enriched in the second component from the separator.

For example, the vapor can compressed to a pressure in which the density of the first component is at least about 5 times, at least about 10 times, at least about 20 times greater than the density of the second component.

In various embodiments, the thermodynamic state (pressure, temperature, and composition) of the vapor provides for a substantially complete separation of the first component from the second component. In some embodiments, the stream enriched in the first component from the separator comprises at least about 70%, at least about 80%, at least about 90%, at least about 95%, or at least about 99% of the first component content of the compressed mixture fed to the high-pressure density-driven separator. For example, the stream enriched in the first component from the separator comprises from about 70% to about 100%, from about 70% to about 99%, from about 70% to about 95%, from about 70% to about 90%, from about 80% to about 100%, from about 80% to about 99%, from about 80% to about 95%, from about 80% to about 90%, from about 90% to about 100%, from about 90% to about 99%, from about 90% to about 95%, from about 95% to about 100% of the first component content of the compressed mixture fed to the high-pressure density-driven separator.

Typically, the stream enriched in the second component from the separator comprises at least about 70%, at least about 80%, at least about 90%, at least about 95%, or at least about 99% of the second component content of the compressed mixture fed to the high-pressure density-driven separator. For example, the stream enriched in the second component from the separator comprises from about 70% to about 100%, from about 70% to about 99%, from about 70% to about 95%, from about 70% to about 90%, from about 80% to about 100%, from about 80% to about 99%, from about 80% to about 95%, from about 80% to about 90%, from about 90% to about 100%, from about 90% to about 99%, from about 90% to about 95%, from about 95% to about 100% of the second component content of the compressed mixture fed to the high-pressure density-driven separator.

In various embodiments of these processes, the first component can comprises at least one, two, three, four or five components selected from the group consisting of carbon dioxide, nitrogen, oxygen, methane, ethane, propane, carbon monoxide, water, sulfur dioxide, nitrogen dioxide, and mixtures thereof. In these and other embodiments, the second component comprises hydrogen.

The processes of the present invention can include any one or more of the various features as described herein.

The present invention is also directed to various apparatus for use with the processes described herein. Some apparatus comprise (a) one or more compressors comprising an inlet for introducing a vapor to the compressor and an outlet for removing a compressed fluid; (b) a high-pressure density-driven separator comprising a vessel, a feed inlet for introducing the compressed fluid to the vessel, a first outlet for removing a stream enriched in a dense fluid from the vessel, and a second outlet for removing the stream enriched a less dense fluid from the vessel, and wherein the feed inlet of the high-pressure density-driven separator is in fluid communication with the outlet of the compressor; and (c) one or more expanders is in fluid communication with the first outlet and/or second outlet of the high-pressure density-driven separator.

As described further herein, various the apparatus comprises a plurality of compressors in series paired with a plurality of expanders is series in an engine configuration and wherein the plurality of compressors comprises the inlet for introducing a vapor to the compressor and the outlet for removing a compressed fluid and the plurality of expanders comprises an inlet in fluid communication with the second outlet of the high-pressure density-driven separator and an outlet for discharging an expanded fluid.

In various embodiments, the feed inlet can comprise a nozzle configured to induce cyclonic fluid motion. In certain embodiments, the nozzle has an orientation that is tangential or approximately normal to the direction of fluid flow in the vessel of the high-pressure density-driven separator.

Also as noted, the vessel of the high-pressure density-driven separator can comprise surface internals such as fins, a porous packing material, and/or a series of capillaries. In various embodiments, the high-pressure density-driven separator further comprises a spiralized conical packing. In some embodiments, the surface internals are configured to induce cyclonic fluid motion.

Further, the high-pressure density-driven separator can further comprise a heat exchanger comprising a tube for flow of a heat transfer fluid. In various embodiments, the vessel of the high-pressure density-driven separator comprises a heat exchanger in a tube-in-tube configuration wherein the vessel forms an outer tube and a heat transfer fluid flows through an inner tube. In other embodiments, the vessel of the high-pressure density-driven separator comprises a heat exchanger in a tube-in-tube configuration wherein the vessel forms an inner tube and a heat transfer fluid flows through an outer tube. In certain embodiments, the vessel of the high-pressure density-driven separator comprises a heat exchanger in a tube-in-shell configuration wherein the vessel forms a shell and a heat transfer fluid flows through a series of enclosed tubes.

The high-pressure density-driven separator of the apparatus described herein can further comprise a second inlet, one or more expanders is in fluid communication with the first outlet of the high-pressure density-driven separator, and the expander comprises an outlet that this in fluid communication with the second inlet of the high-pressure density-driven separator.

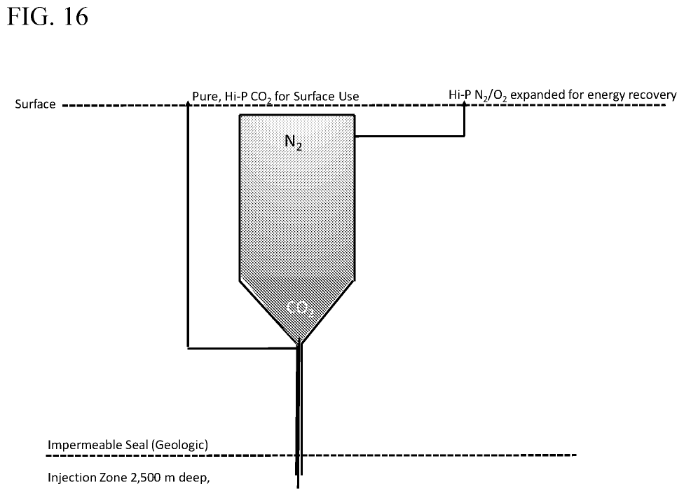

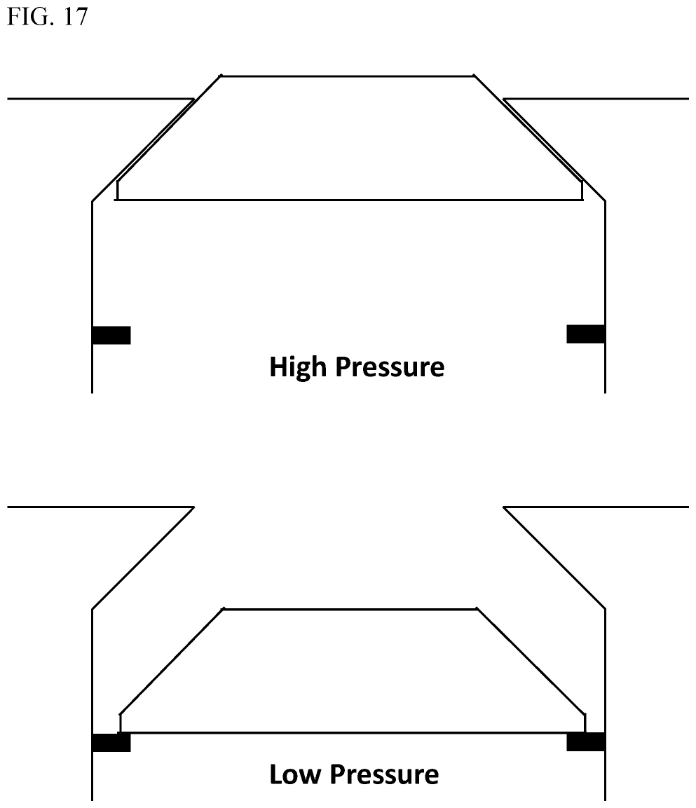

As discussed further herein at least a portion of the apparatus can be positioned underground. Also, the apparatus can further comprise an underground well in fluid communication with the first outlet and/or second outlet of the high-pressure density-driven separator. See FIG. 16. The underground well can comprise self-sealing cap which is configured to be open at low pressure and sealed at high pressure. For example, See FIG. 17.

### Section I. HDS (High-Pressure Density-Driven Separator)

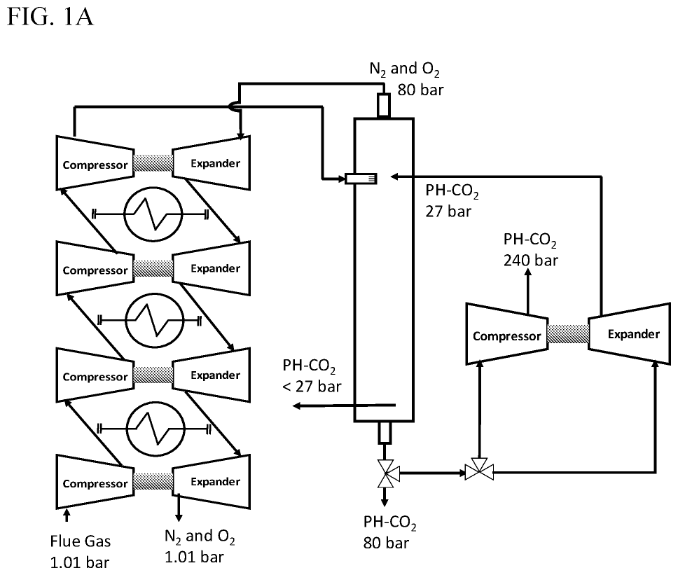

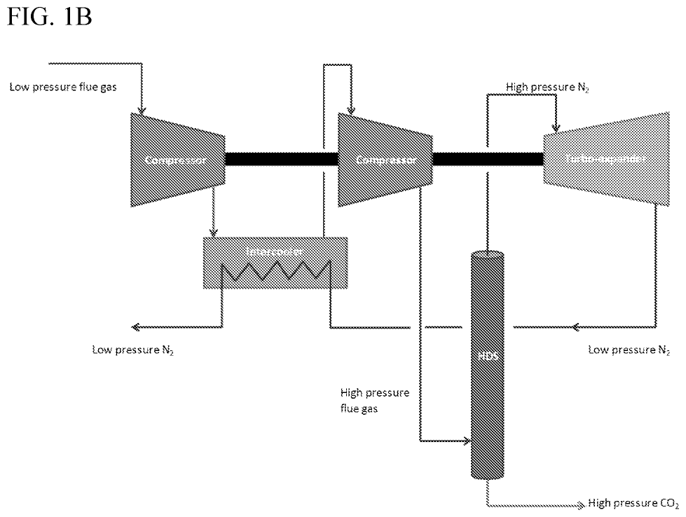

In various processes, a vapor (e.g., exhaust gas or flue gas) comprising carbon dioxide and at least one other component is pressurized in a compressor or series of compressors. FIGS. 1A and 1B are process flows diagrams. Four stages of compression are shown in FIG. 1A, and two stages of compression are shown in FIG. 1B. In various embodiments, the compression ratios required to achieve optimum pressure range for the high-pressure density-driven separator is about 3.

Carbon dioxide is removed continuously by means of a High-pressure Density-driven Separator (HDS). FIG. 1A shows two further process options for the high-pressure carbon dioxide stream. The first option is to expand the high-pressure carbon dioxide to recover energy and/or remove heat from the high-pressure density-driven separator. The carbon dioxide becomes a heat transfer fluid that circulates inside the high-pressure density-driven separator to cool surfaces. The second option is to further compress the carbon dioxide for pipeline transport, sequestration and/or use (e.g., enhanced oil recovery). In some embodiments, both options can occur with portions of the separand. In that mode of operation, the compressor and expander can be paired, as discussed in the next paragraph.

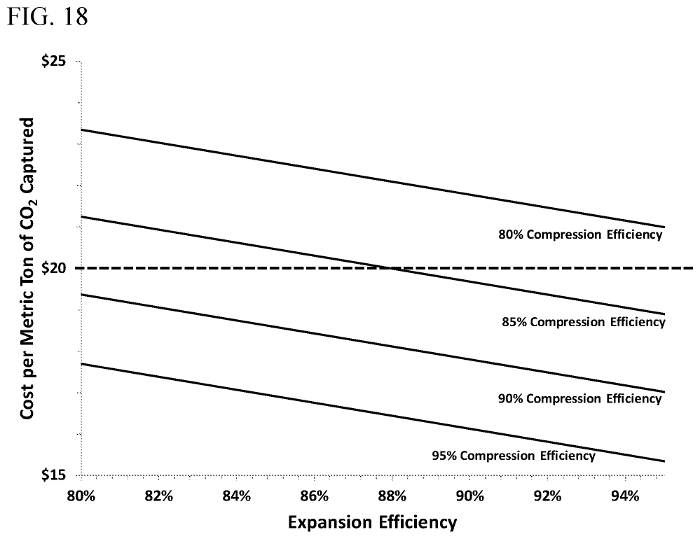

The remaining vapors, also at high-pressure, can be expanded in one or more turbo expanders to recover the work required for compression. FIG. 1A shows a series of four expanders for this purpose. They are paired with the four compressors and have similar compression ratios. Each pair of compressors and expanders can operate together as an engine. They exchange heat for intercooling and inter-heating. For example, if the vapor feed contains about 15 mole % carbon dioxide (e.g., flue gas from a coal-burning power plant), then about 85 mole % of the vapor compressed can be expanded back to its original state and released to the environment. Further, moderate temperature heat transfer fluids, including process streams, ambient fluids, and/or fluids from other operations, can also be used to improve compression and expansion efficiencies, as well as carbon dioxide separation volumetric efficiency. These configurations are explored through the application of thermodynamic principles (subject to attainable efficiencies) in detailed mass and energy balances. They form the bases for cost estimates. FIG. 18 provides cost estimates based on a thermodynamic model corresponding to FIG. 1A.

The process is suitable for carbon dioxide capture from any large-scale combustion processes including but are not limited to power plants burning carbonaceous fuels such as coal, fuel oil, natural gas, as well as biomass- and refuse-derived fuels. The typical composition of flue gas from a coal-burning power plant is shown in Table 1. Power plants with other fuels can generate somewhat less carbon dioxide. The invention also applies to upgrading of fuel gases containing carbon dioxide. Fuel gases include: natural gas, shale gas, town gas, producer gas, and biogas. The invention also applies to separation of hydrogen vapor solutions including upgraded fuel gas. Electricity can be produced directly from hydrogen and air in a fuel cell.

TABLE 1
Typical composition of flue gas from a coal burning power plant
operating with 20% excess air. Note that below about 0.3 MPa,
volume % and mole % are equivalent in the vapor phase.
Dry Flue Gas Composition (vol %)

| | |
|---|---|
| carbon dioxide | ≈16% |
| nitrogen | ≈79% |
| oxygen | ≈5% |
| CO | <<1% |
| NO_{X} | |
| SO_{X} | |

A fluid becomes supercritical above its critical temperature (T_{C}) and its critical pressure (P_{C}). Table 2 shows the critical parameters for fluids in flue gas. Note that atmospheric pressure is 0.101325 MPa.

TABLE 2
Critical temperature and critical pressure for flue gas
components, fuel gas components, and water.
Gas Components, Fuel Gas Components, and Water

| Species | T_{C} (° C.) | P_{C} (MPa) |
|---|---|---|
| CO₂ | 31 | 7.38 |
| N₂ | −147 | 3.4 |
| O₂ | −118.6 | 5.05 |
| CH₄ | −82.6 | 4.6 |
| CO | −140.3 | 3.49 |
| H₂ | −240 | 1.3 |
| H₂O | 374 | 22.06 |

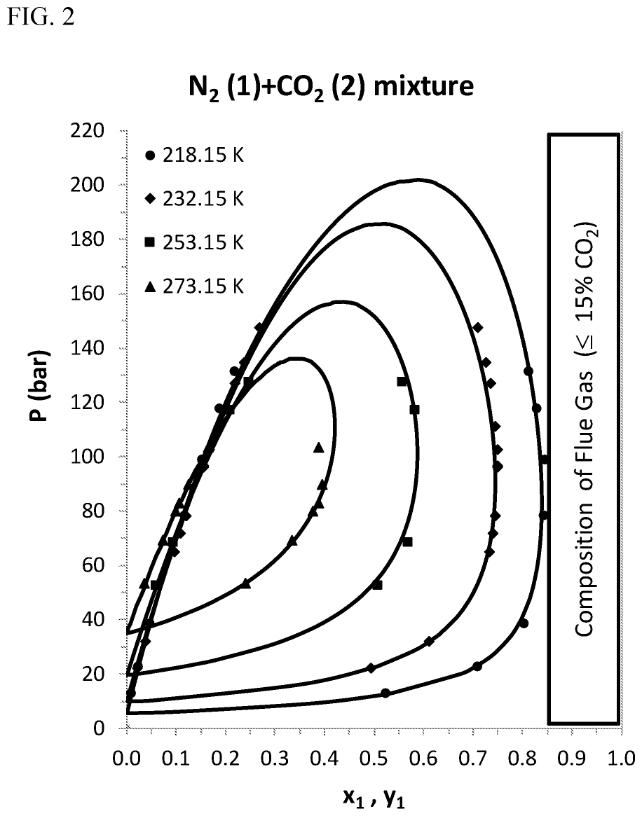

Super critical fluids are a distinct phase of matter and cannot be condensed to a liquid at any pressure. However, below its critical temperature (31° C. or 304 K), high-pressure carbon dioxide can exist as a liquid. It has been proposed to remove liquid carbon dioxide from flue gas at low temperature and high pressure, since it is much less volatile than the other components of mixture. The basis for this separation is referred to as vapor-liquid equilibrium (VLE). Yet VLE-based separation of nitrogen and carbon dioxide, the primary components of flue gas, is not possible, even at temperatures as low as −55° C. (218 K). This is because the carbon dioxide is too dilute in the flue gas. This is shown in FIG. 2, which is a Pxy diagram that was generated by a model we developed for prediction of vapor-liquid equilibria for mixtures of low-boiling point compounds. It shows the composition of liquid (x) and vapor (y) that are in equilibrium. At or above 85% nitrogen mole fraction (at or below 15% carbon dioxide mole fraction), only vapor mixtures exist. Thus, phase equilibrium separations via VLE cannot be accomplished.

I.1 Density-Driven Separation Concept

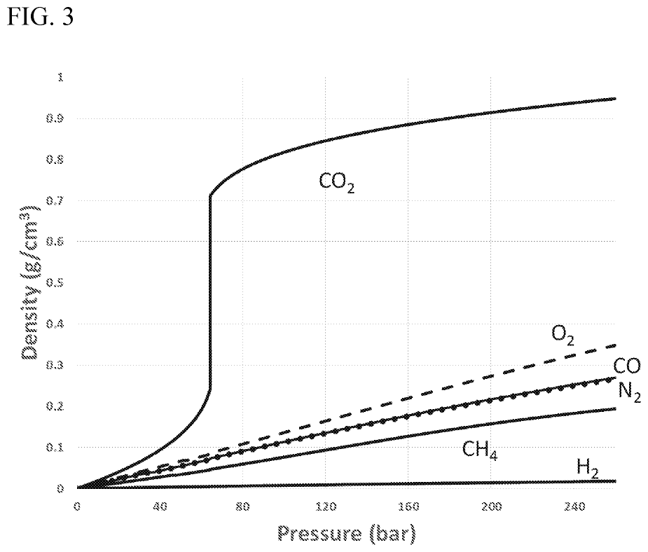

Separations are based on differences in physical and/or chemical properties among the compounds to be separated. As discussed above, phase (liquid or vapor) is one of these properties. Density can also be used as the basis for a separation, even among fully miscible components. The density of a fluid is a function of its state (temperature, pressure, and composition). The present invention identifies the fluid state that leads to separation of carbon dioxide from other components in a gas mixture. FIG. 3 shows the density of carbon dioxide as a function of pressure at 25° C. For comparison, the other main components of flue gas (nitrogen and oxygen) are also shown. Above 70 bar (7 MPa), the density of carbon dioxide exceeds the density of the other components of flue gas by an order of magnitude. Also plotted are the representative components of fuel gases (methane, carbon monoxide, hydrogen). While the density of carbon monoxide is nearly identical to the density of nitrogen, both methane and hydrogen are even less dense. Therefore, these components can also be separated from carbon dioxide in a high-pressure density-driven separator. A further observation is that hydrogen is much less dense than any of the other components. Therefore, hydrogen can also be separated from a mixture containing at least one of the following components (in addition to carbon dioxide): nitrogen, oxygen, methane, carbon monoxide, ethane and/or propane. For example, fuel gases could receive a second upgrading step after separation of carbon dioxide (if present). The nearly pure, high-pressure hydrogen produced can be burned in fuel cells to generate electricity directly and efficiently (among other uses). This defines the utility of the high-pressure density-driven separator technology for upgrading fuel gases that contain carbon dioxide.

FIG. 3 shows that a mixture of nitrogen and carbon dioxide will stratify in a high pressure vessel. Carbon dioxide will settle, while nitrogen will rise. This separation is accomplished as a result of the relative buoyancy of the two species in the gravitational field. We demonstrated this density-driven separation in batch mode in our publication in the Journal of CO₂ Utilization (“Exploration of High Pressure Separations of Nitrogen and Carbon Dioxide.” Hendry 2013). This publication (Hendry 2013) is incorporated herein by reference. However, Hendry 2013 does not form the basis for a practical technology for treating large volumes of flue gas. This is because batch processing is inherently less efficient than continuous processing. We demonstrated that the continuous processing of flue gas is possible in our publication in the Journal of CO₂ Utilization (“Separation of N₂/CO₂ Mixture Using A Continuous High-pressure Density-driven Separator.” Espanani 2016). This publication (Espanani 2016) is incorporated herein by reference.

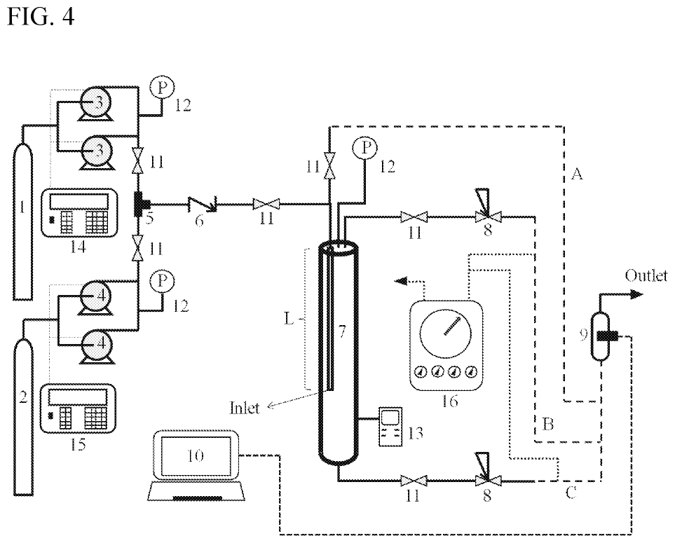

The apparatus used to generate the published continuous separation data is shown as FIG. 4.

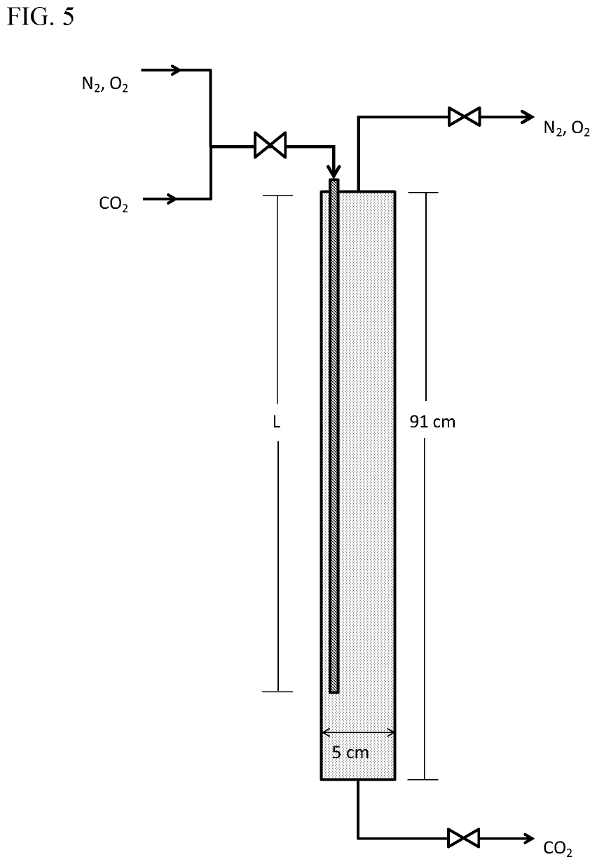

The publication (Espanani 2016) describes a mixture of 15% carbon dioxide and 85% nitrogen (by volume or mole) fed continuously to our first prototype high-pressure density-driven separator (HDS-1) at ambient temperature and pressures from 17 to 24 MPa. HDS-1 is shown schematically in FIG. 5. Note the fluid is introduced in the axial direction. The vertical distance between the inlet port and the upper outlet port is “L,” a key design parameter.

A metric reflecting the effectiveness of the separation, “S,” is defined below. This metric ranges between 1 (perfect separation) and 0 (no separation).

$$S = {( \frac{{y}_{{N}_{2} , out} - {y}_{{N}_{2} , in}}{1 - {y}_{{N}_{2} , in}} )}_{top}$$

We correlated the performance of HDS-1, as reflected by “S” with the product of two dimensionless groups. The first is the Archimedes Number. It is defined below.

$$Ar = \frac{buoyant force}{viscous force} = \frac{{gL}^{3} {ρ}_{mix} {ρ}_{mix} ( {ρ}_{{CO}_{2}} - {ρ}_{{N}_{2}} )}{{μ}_{{N}_{2}}^{2}}$$

In this equation, g is the acceleration of gravity, ρ refers to the density of the subscripted species, and μ_{N2} is the viscosity of nitrogen. These fluid parameters are evaluated at the pressure and temperature of operation.

The second dimensionless group is the Espanani Number, which is defined as:

$$Es = \frac{pressure force}{viscous force} = \frac{P \times L}{U \times μ} = \frac{P \times {τ}^{′}}{μ} .$$

In this expression, P is the pressure, L is the vertical distance between the inlet and outlet ports of the high-pressure density-driven separator (see FIG. 4 and FIG. 5), U is the linear velocity of the fluid, and μ is the viscosity of the fluid. τ′ is L/U, which is the time required for the average molecule to travel from the inlet port to the outlet port of the high-pressure density-driven separator.

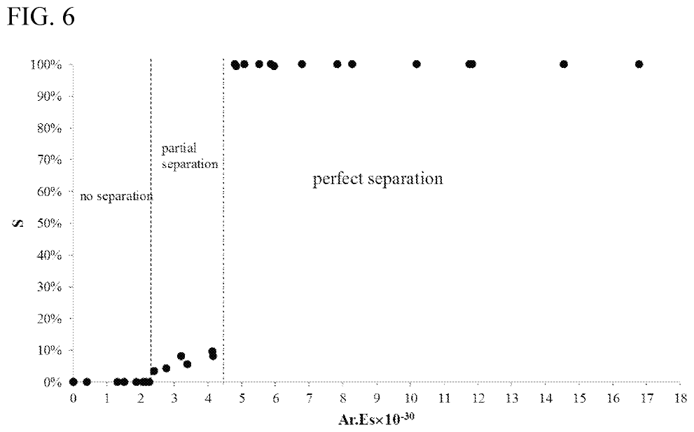

FIG. 6 shows the performance of HDS-1 as a function of the product of the Archimedes Number and the Espanani Number.

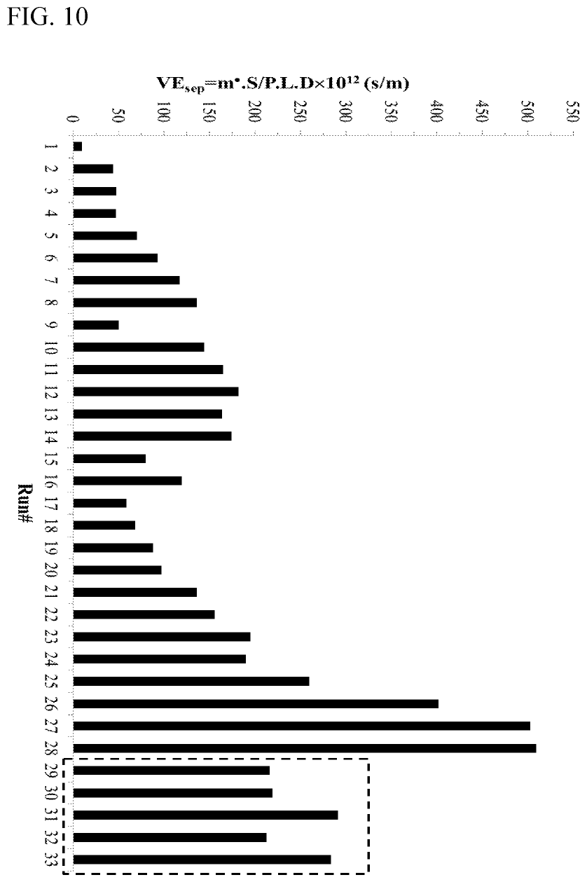

The process has now been shown to be highly effective for separation of carbon dioxide from oxygen, methane, carbon monoxide, and hydrogen, and mixtures thereof. Indeed, examination of FIG. 3 reveals that separation of carbon dioxide from oxygen and methane can be accomplished. This has been established experimentally (see FIG. 10 and Table 5). Separation of carbon dioxide from methane and hydrogen will be superior. This defines the utility of the high-pressure density-driven separator technology for upgrading fuel gases that contain carbon dioxide. As noted, hydrogen can be separated from all remaining components as a second step after carbon dioxide separation has been accomplished.

HDS-1 was designed to allow exploration of L values from 15 cm to 76 cm. L was limited by the height of the column. The optimum value of L also depends on the flow rate (inlet velocity), pressure, height, and diameter of the column. We have developed metrics and engineering calculations to determine this optimum value, and these are discussed below. In general, and if H is the height of the column, bounds on L are as follows (measured top down):

0.3<L/H<0.95

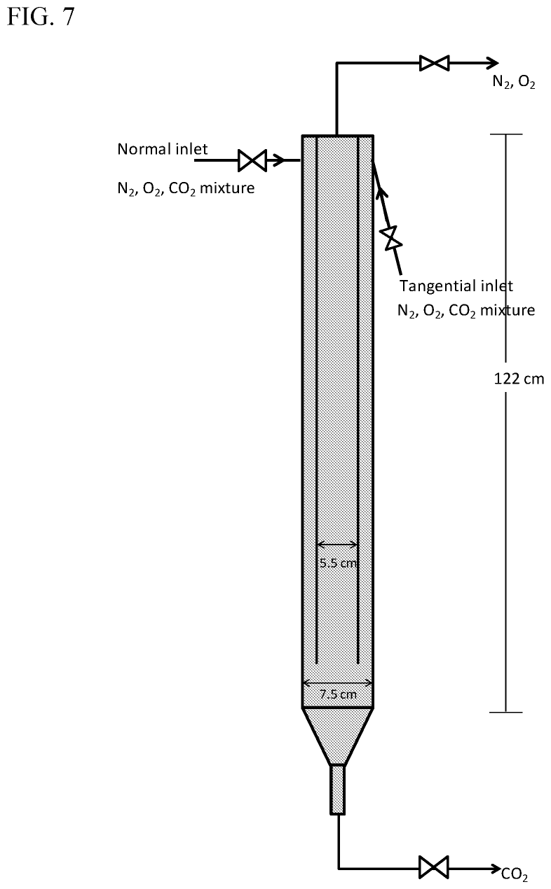

In order to widen this range in absolute terms, we designed and built a second prototype, HDS-2 (see FIG. 7 and discussion thereof below) that was significantly taller than HDS-1.

In the text above, fluid states were identified (high-pressure, ambient temperature, various compositions) that lead to complete separation. This is a thermodynamic phenomenon. The rate of approach to this equilibrium-based separation is the key to implementation of the technology. This is a kinetic phenomenon. Three synergistic modes of enhancement improve the kinetics (increase the rate) of the separation. First, hydrodynamic enhancement in which fluid motion improves performance. Second, further exploration of fluid state enhancement and sub-ambient temperature of the fluid as well as internal surfaces in the vessel. Third, surface effects enhancement and design of internal surface area on the macroscopic-, microscopic-, and nano-scale. These three modes of performance enhancement are discussed individually here.

I.2 Hydrodynamic Enhancement of Density-Driven Separation

The first means of enhancement of the performance of the high-pressure density-driven separator explored is “hydrodynamics.” This involves manipulating the fluid flow to enhance the separation driven by density differences in a gravimetric field. Thus, in various embodiments, the inlet comprises a port and a nozzle, wherein the port has an orientation (e.g., tangential to the column) and the nozzle has a design such that they induce fluid motion that enhances the performance of the high-pressure, density-drive separator. Cyclonic motion causes a centrifugal force field that can work in concert with the gravimetric field to enhance separation in the high-pressure density-driven separator.

HDS-2 is operated with two types of inlet ports, normal (radial) and tangential. This is in contrast to HDS-1, which had introduced the fluid in an axial direction. A schematic is shown in FIG. 7.

The first type of inlet port is “normal.” Using this port, the fluid is aimed in the radial direction (toward the center of the high-pressure density-driven separator). The second type of inlet port is tangential. As the name implies, when using this port the fluid is introduced tangentially, creating a swirling flow and a centrifugal force that acts more strongly on the more dense fluid.

In our exploration of hydrodynamics as a means of increasing high-pressure density-driven separator performance, we performed a set of comparative experiments testing the null hypothesis (S_{Tan}=S_{Norm}) against the alternate hypothesis (S_{Tan}>S_{Norm}) where “S_{Tan}” is the mean value of the separation metric for tangential port data, and S_{Norm} is the mean value of the metric for the normal port data. The data are shown in Table 3.

TABLE 3
Data from comparative experiments
testing hydrodynamic hypotheses.

| P (MPa) | m•_{N2} (mol/min) | m•_{CO2} (mol/min) | S_{Tan} | S_{Norm} |
|---|---|---|---|---|
| 10.3 | 0.0853 | 0.0128 | 50% | 28% |
| 13.8 | 0.1123 | 0.0168 | 97% | 84% |
| 17.2 | 0.1382 | 0.0207 | 100% | 90% |
| 20.7 | 0.2440 | 0.0365 | 97% | 74% |

The data were evaluated using the “paired t-test” procedure. The results of the analysis are shown in Table 4.

TABLE 4
Analysis of comparative experiments testing hydrodynamic hypotheses.
t-Test: paired Two Sample for Means

| | S_{Tan} | S_{Norm} |
|---|---|---|
| Mean | 0.86 | 0.69 |
| Variance | 0.057807 | 0.079067 |
| Observation | 4 | 4 |
| Pearson Correlation | 0.982811 | |
| Hypothesized Mean Difference | 0 | |
| df | 3 | |
| t Stat | 5.385855 | |
| P(T <= t)one-tail | 0.00627 | |
| t Critical one-tail | 2.353363 | |
| P(T <= t)two-tail | 0.012539 | |
| t Critical two-tail | 3.182446 | |

The probability (P(T<=t) one tail) is interpreted as follows, 0.6% of the time a difference in means as great as the one observed would occur by random chance. This discredits the null hypothesis in favor of the alternative hypothesis. Therefore, Table 4 demonstrates the hydrodynamic enhancement of high-pressure density-driven separator performance.

I.3: Fluid State Enhancement of Density-Driven Separation

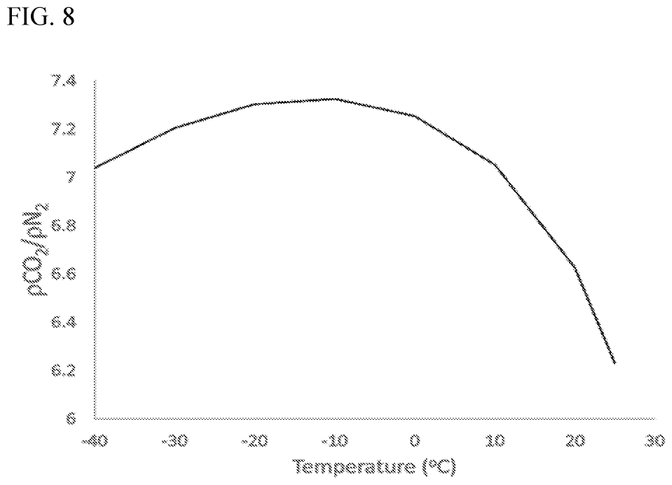

The thermodynamic state of a gas mixture is defined by its pressure, temperature, and composition. The operating pressure range is discussed above. Another strategy for enhancing the performance of the high-pressure density-driven separator is to reduce the temperature of the surfaces within high-pressure density-driven separator itself, and of the gas being processed. A fundamental observation of the pure fluids carbon dioxide and nitrogen is shown in FIG. 8, which shows reduction in temperature enhances density difference down to about −10° C.

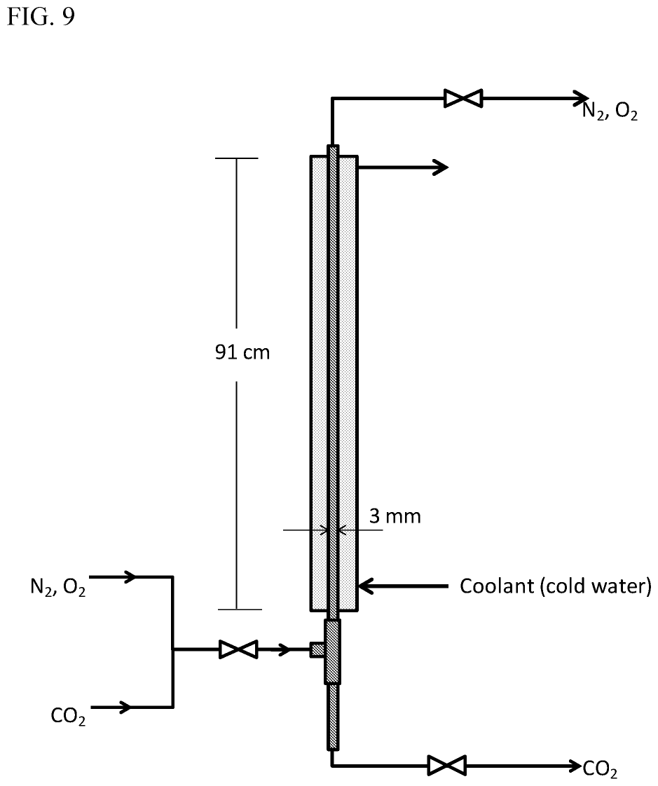

FIG. 9 is a schematic of HDS-3, designed and built to test this hypothesis. The nitrogen:carbon dioxide solution (85%:15% by volume or mole flows in the inner tube shown in green). The heat transfer fluid flows in the outer annulus (ice water shown in blue). In the parlance of heat exchangers, this is a tube-in-tube. In this configuration, the heat transfer surface area is determined by the ID of the inner tube and is 91 cm². The flow volume is based on the ID and length of the inner tube and is 8 cm³. This results in a surface area to volume ratio of 11 m⁻¹. An alternative mode of operation is to put the heat transfer fluid in inner tube, and the nitrogen:carbon dioxide solution in the outer annulus and this will be discussed below.

The volume of HDS-3 is small relative to HDS-2 (or HDS-1), as indicated by the dimensions on FIGS. 5, 7 and 9. Therefore it was necessary to define a metric, “VEₛₑₚ,” that allows the performance of different high-pressure density-driven separator prototypes to be directly compared, as required by the iterative design and development process. VEₛₑₚ is defined below.

$${VE}_{sep} = \frac{{\dot{m}}_{carbon dioxide} S}{PDL}$$

We seek to maximize the terms in the numerator; \dot{m}_{carbon dioxide} is the mass flow rate of carbon dioxide entering the high-pressure density-driven separator, and S is the separation metric defined above. We seek to minimize the terms in the denominator; P is the operating pressure (Pa), and L is the dimension parallel to the gravimetric field, and D is the dimension perpendicular to the gravimetric field. In FIG. 10, this metric is used to compare the performance of four high-pressure density-driven separator prototypes in various modes of operation. Table 5 describes the conditions and configurations corresponding to the run numbers in FIG. 10.

TABLE 5
Conditions and configurations for comparitive experiments
using high-pressure density-driven separator prototypes.

| Run# | mixture | HDS | Inlet stream | T (° C.) | P (bar) | packing |
|---|---|---|---|---|---|---|
| 1 | N₂ + CO₂ | 1 | normal | 25 | 172.4 | No packing |
| 2 | N₂ + O₂ + CO₂ | 2 | normal | 25 | 172.4 | No packing |
| 3 | N₂ + O₂ + CO₂ | 2 | normal | 25 | 186.2 | Stainless steel ball (d = 1.27 cm) |
| 4 | N₂ + O₂ + CO₂ | 2 | normal | 25 | 137.9 | Stainless steel ball (d = 1.27 cm) |
| 5 | N₂ + O₂ + CO₂ | 2 | normal | 25 | 137.9 | Stainless steel ball (d = 1.27 cm) |
| 6 | N₂ + O₂ + CO₂ | 2 | normal | 25 | 137.9 | Stainless steel ball (d = 1.27 cm) |
| 7 | N₂ + O₂ + CO₂ | 2 | normal | 25 | 137.9 | Stainless steel ball (d = 1.27 cm) |
| 8 | N₂ + O₂ + CO₂ | 2 | normal | 25 | 137.9 | Stainless steel ball (d = 1.27 cm) |
| 9 | N₂ + O₂ + CO₂ | 2 | tangential | 25 | 172.4 | No packing |
| 10 | N₂ + O₂ + CO₂ | 2 | tangential | 25 | 137.9 | Stainless steel ball (d = 1.27 cm) |
| 11 | N₂ + O₂ + CO₂ | 2 | tangential | 25 | 151.7 | Stainless steel ball (d = 1.27 cm) |
| 12 | N₂ + O₂ + CO₂ | 2 | tangential | 25 | 151.7 | Stainless steel ball (d = 1.27 cm) |
| 13 | N₂ + O₂ + CO₂ | 2 | tangential | 25 | 103.4 | Stainless steel ball (d = 1.27 cm) |
| 14 | N₂ + O₂ + CO₂ | 2 | tangential | 25 | 89.7 | Stainless steel ball (d = 1.27 cm) |
| 15 | N₂ + O₂ + CO₂ | 3 | normal | 18 | 172.4 | No packing |
| 16 | N₂ + O₂ + CO₂ | 3 | normal | 18 | 172.4 | Glass beads (d = 1 mm) |
| 17 | N₂ + O₂ + CO₂ | 4 | normal | 25 | 172.4 | No packing |
| 18 | N₂ + O₂ + CO₂ | 4 | normal | 18 | 172.4 | No packing |
| 19 | N₂ + O₂ + CO₂ | 4 | normal | 25 | 172.4 | Glass beads (d = 1 mm) |
| 20 | N₂ + O₂ + CO₂ | 4 | normal | 18 | 172.4 | Glass beads (d = 1 mm) |
| 21 | N₂ + O₂ + CO₂ | 4 | normal | 25 | 172.4 | Glass beads (d = 3 mm) |
| 22 | N₂ + O₂ + CO₂ | 4 | normal | 18 | 172.4 | Glass beads (d = 3 mm) |
| 23 | N₂ + O₂ + CO₂ | 4 | normal | 11 | 172.4 | Stainless steel ball (d = 4.8 mm) |
| 24 | N₂ + O₂ + CO₂ | 4 | normal | 25 | 172.4 | Stainless steel ball (d = 6.4 mm) |
| 25 | N₂ + O₂ + CO₂ | 4 | normal | 11 | 172.4 | Stainless steel ball (d = 6.4 mm) |
| 26 | N₂ + O₂ + CO₂ | 4 | normal | 11 | 137.9 | Stainless steel ball (d = 6.4 mm) |
| 27 | N₂ + O₂ + CO₂ | 4 | normal | 11 | 137.9 | Stainless steel ball (d = 6.4 mm) |
| 28 | N₂ + O₂ + CO₂ | 4 | normal | 11 | 103.4 | Stainless steel ball (d = 6.4 mm) |
| 29 | CH₄ + CO₂ | 4 | normal | 11 | 172.4 | Stainless steel ball (d = 4.8 mm) |
| 30 | CH₄ + CO₂ | 4 | normal | 25 | 172.4 | Stainless steel ball (d = 6.4 mm) |
| 31 | CH₄ + CO₂ | 4 | normal | 11 | 172.4 | Stainless steel ball (d = 6.4 mm) |
| 32 | CH₄ + CO₂ | 4 | normal | 25 | 137.9 | Stainless steel ball (d = 6.4 mm) |

HDS-3, shown in FIG. 9, was operated with cooling water in the annular region and no packing during our first attempt at inclusion of a reduced-temperature surface. In the experiments reported here, the vapor to be treated (85% nitrogen, 15% carbon dioxide) flowed at 10 MPa (100 bar) in the center tube, while ice water flowed through the outer annulus. Therefore, the wall of the inner tube is at 0° C. The (pure) nitrogen stream exits the top of HDS-3 at about 11° C. The temperature of this carbon dioxide stream is about 18° C. Table 6 shows the runs that reveal the efficacy of temperature reduction as a means toward enhancing the performance of a high-pressure density-driven separator.

TABLE 6
Runs with coolant in HDS-3 and with and without coolant
in HDS-4. Refer to FIG. 10 for performance data.

| Prototype | Run #'s without Coolant | Run #'s with Coolant |
|---|---|---|
| HDS-3 | | 15, 16 |
| HDS-4 | 17, 19, 21, 24, 30, 32 | 18, 20, 22, 23, 25-29, 31 |

Examination of Tables 5 and 6, together with FIG. 10 shows significant performance enhancement due to the use of coolant to reduce temperatures of surfaces and fluids inside the high-pressure density-driven separator. Run #15 in HDS-3 was our first run with coolant and yielded better results than all previous high-pressure density-driven separator experiments (run order is not sequential). Run #16, which included packing as well as coolant, was better still.

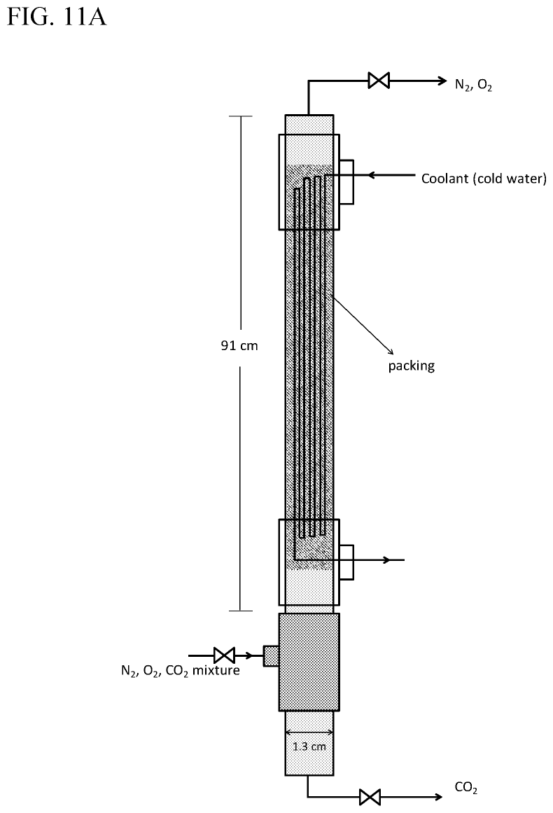

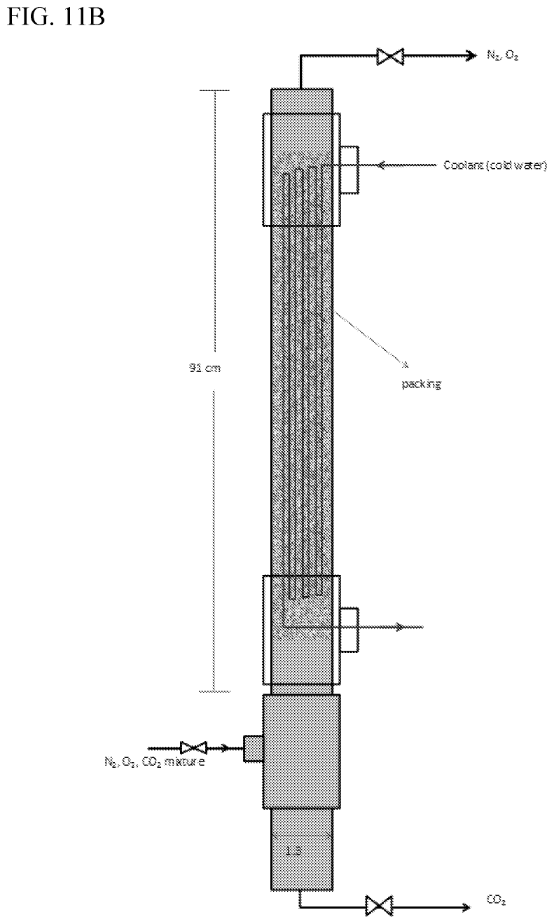

A fourth prototype, HDS-4, was fabricated to further explore thermal enhancement of density-driven separation. It is shown as FIG. 11A. The nitrogen+oxygen+carbon dioxide solution (or methane+carbon dioxide in some experiments) flows on the shell-side, while the heat transfer fluid flows on the tube side. Although FIG. 11A shows packing on the shell side of HDS-4, comparative experiments were run without packing and are discussed below. HDS-4 has 3 “passes” on the tube side resulting in a heat transfer surface area of 272 cm². The flow volume is 125 cm³. This gives a surface area to volume ratio of 2.2 cm⁻¹. By contrast, in HDS-3, the nitrogen:carbon dioxide solution flows on the tube side. It has a heat transfer area of 91 cm², and a flow volume of 8 cm³. This gives a surface area to volume ratio of 11.3 cm⁻¹. Since HDS-3 has a higher surface area to flow volume ratio. It also provides higher high-pressure density-driven separator performance (in the absence of packing). The relevant comparison is Run #15 (high-pressure density-driven separator 3, cooling water, no packing) with Run #18 (HDS-4, cooling water, no packing) shown in FIG. 10 and Table 5.

Direct comparisons of coolant and no coolant were made using HDS-4, holding other conditions constant. These comparisons include Run #17 versus Run #18, Run #19 versus Run #20, and Run #21 versus Run #22, Run #24 versus Run #25, and Run #30 versus Run #31. In all direct comparisons the use of coolant significantly increased high-pressure density-driven separator performance. In the aggregate, all runs with coolant exhibit better performance than runs without coolant.

Finally, note that Runs #23, #25-#29, and #31 achieved an exit carbon dioxide temperature of 11° C., while the remaining runs with coolant achieved 15° C. Examination of FIG. 10 shows these runs in which the coolant achieved the lowest temperature were the most effective to date. This demonstrates the thermal enhancement of density-driven separation.

The means of achieving this reduction in temperature is also unique to this application. FIG. 1A shows two process options for the high-pressure carbon dioxide stream removed continuously from the high-pressure density-driven separator. The first option is to expand the high-pressure carbon dioxide and the second option is to further compress the carbon dioxide (for pipeline transport, sequestration and/or use e.g., enhanced oil recovery). The first option, expansion of the high-pressure carbon dioxide, recovers work required to compress it. It also creates a coolant that can be recirculated inside the high-pressure density-driven separator.

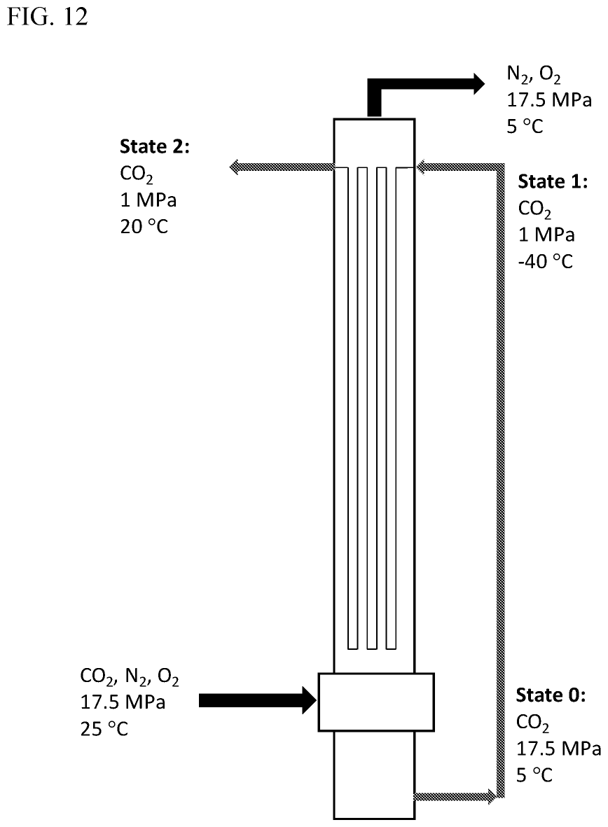

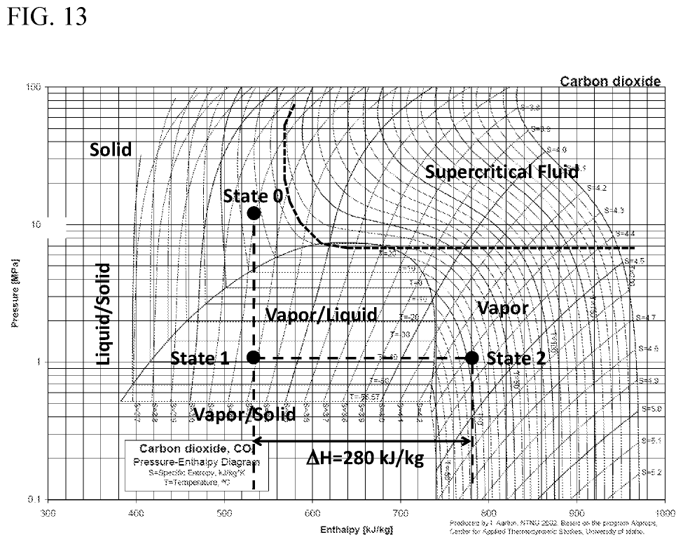

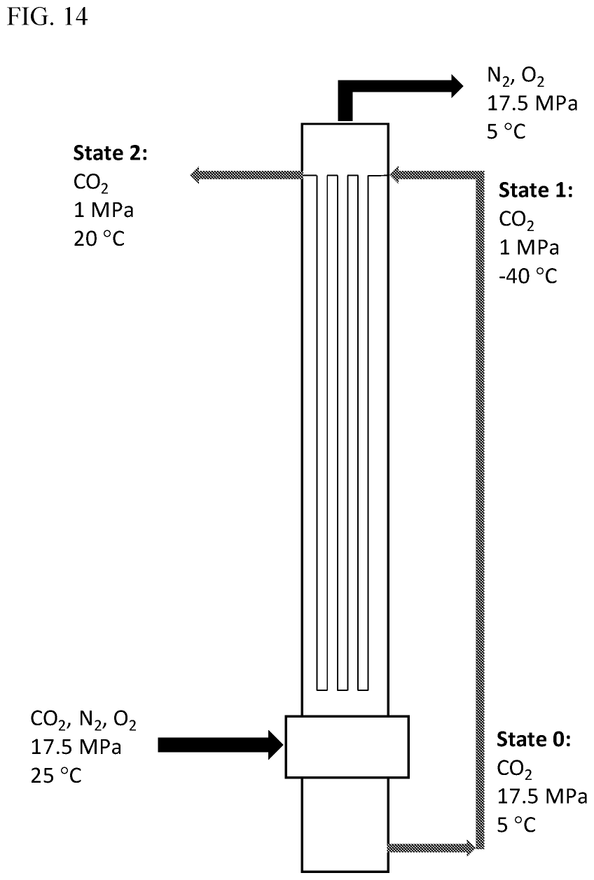

FIG. 12 shows recirculation the carbon dioxide separand (product stream) through the “tube-side” of and high-pressure density-driven separator, while the flue gas flows through the “shell side.” Useful changes of state, which can occur in an external expander, as shown in FIG. 1, or as the carbon dioxide flows in the in the tube side, as illustrated in FIG. 12 and FIG. 14. As an example, one of these useful changes in state is illustrated using FIG. 13, which is a pressure enthalpy diagram for pure carbon dioxide. Changes in state (0→1→2) are shown on the P-H diagram (FIG. 13).

In the proposed process and referring to FIG. 12, the carbon dioxide separand leaves the high-pressure density-driven separator as a pure stream at 17.5 MPa (175 bar) and 5° C. This is point “0” on the P-H diagram that is FIG. 13. The carbon dioxide undergoes isenthalpic expansion to 1 MPa and −40° C. This expansion is referred to as “throttling,” and occurs in FIG. 12 in the recirculation loop. The throttling is accomplished by flow through an obstruction(s) or porous materials. This mixture of liquid and vapor resulting from throttling is shown as point “1” in FIG. 13.

This cold mixture is circulated through the high-pressure density-driven separator as a heat transfer fluid in cooling coils as shown in FIG. 12. The fluid undergoes an isobaric warming to 20° C. and is 100% vapor. This state is indicated by point “2” on FIG. 13. The recirculating carbon dioxide stream absorbs 280J/kg carbon dioxide from the feed stream. The path shown on FIG. 13 is but one of many between desired thermodynamic states. The concept is recirculation of carbon dioxide separand such that it undergoes a change in state that facilitates its use as a heat transfer fluid to cool surface internals to the high-pressure density-driven separator and the gas mixture to be separated. Another coolant can also be used.

The expansion and heat transfer can happen simultaneously in the “tube-side” of the high-pressure density-driven separator shown in FIG. 14. In this configuration, the recycle loop is internal to the high-pressure density-driven separator. The pressure drop is accomplished through viscous flow in thin tubes or flow through tubes of larger diameter containing packing. The packing can be fibrous or porous material with high thermal conductivity. It will also have void fraction and characteristic dimensions (pore diameter or fiber diameter) such that appropriate pressure drop is achieved for the desired change in phase.

The change in state of the carbon dioxide separand is also shown in FIG. 1A. In that Figure, an expander and compressor linked on the same shaft illustrate that the carbon dioxide separand may be expanded to create a heat transfer fluid as described above, or compressed for transport, enhanced oil recovery, sequestration, or other use. Both operations can occur simultaneously, each with a portion of the separand stream.

I.4: Surface Effects Enhancement of Density-Driven Separation

The first three prototypes (HDS-1 shown in FIG. 5, HDS-2 in FIG. 7, and HDS-3 shown in FIG. 9) were essentially empty cylinders with little internal surface area. The HDS-designs shown in FIG. 11A, FIG. 11B, FIG. 12, and FIG. 14 include internal surface area. In the absence of packing, this internal surface area is comprised of the walls of the tubes in which coolant flows as a heat transfer fluid and the walls of the vessel. FIG. 11A, FIG. 11B, and FIG. 14 illustrate the concept of packing in the tube side to accomplish desirable change in phase in the heat transfer fluid (pressurized carbon dioxide). In this subsection, the focus is on the shell side. In configurations similar to FIG. 11A, FIG. 11B, FIG. 12, and FIG. 14 the shell side is where the pressurized gas mixture undergoes separation.

Placing packing in the shell side creates surface area in direct contact with the pressurized gas mixture gas being treated. This affects the separation rate in two ways. The first is as a heat transfer surface area. To a point, increasing the ratio of heat transfer surface area to flow volume will result in an increase in high-pressure density-driven separator performance. This was shown in the previous section. The second manner in which surface area affects the separation rate is the manner in which the pressurized carbon dioxide interacts with the surfaces in the high-pressure density-driven separator. This interaction includes surface tension driven flow; wetting and wicking of carbon dioxide on high-energy surfaces. This scale of this interaction increases in tandem with increase of heat transfer area.

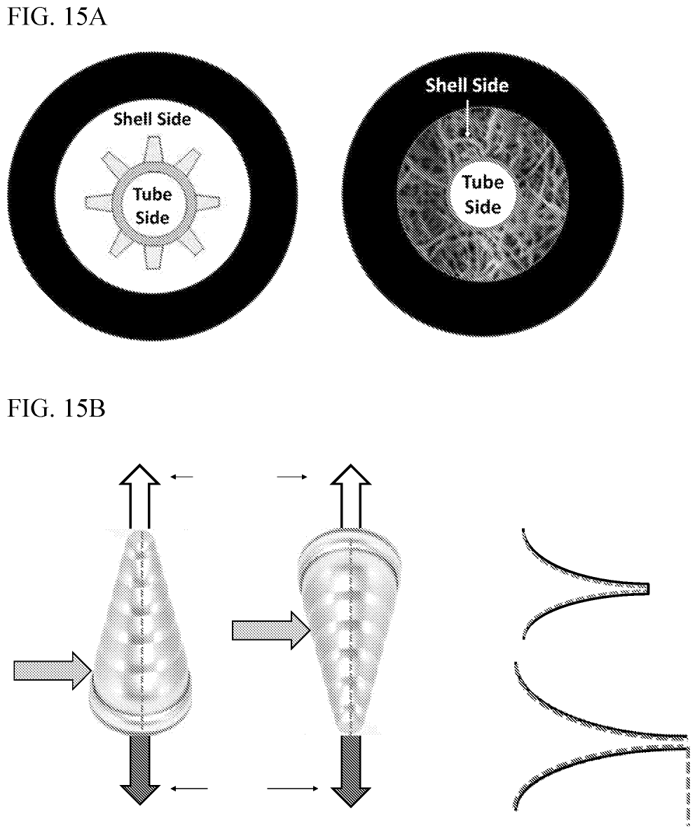

One way to explore the effect of surface area is to put packing material on the shell-side. This adds the surface area of the packing (which we postulate is good), at the expense of flow volume (and residence time, which we know is bad). The concept is illustrated in FIG. 11A, FIG. 11B, and FIG. 14, as well as below in FIGS. 15A and 15B.

Quartz glass beads (1 mm and 3 mm) and stainless steel balls (1.3 mm, 4.8 mm, and 6.4 mm) were used as packing due to their high surface energy. These were placed in the shell side of HDS-2, HDS-3, and HDS-4, in various configurations. Run #'s with packing and Run #'s without packing is tabulated below. Refer to Table 5 for experimental conditions and FIG. 10 for performance data.

TABLE 7
Run #'s with packing and Run #'s without
packing in three prototypes. Refer to Table 5 for
experimental conditions and FIG. 10 for performance data.

| Prototype | Run #'s without Packing | Run #'s with Packing |
|---|---|---|
| HDS-2 | 2, 9 | 3-8, 10-14 |
| HDS-3 | 15 | 16 |
| HDS-4 | 17, 18 | 19-32 |

Examination of Tables 5 and 6, together with FIG. 10 shows significant performance enhancement due to the presence of packing. This is true for pairs of directly comparative runs: Run #15 versus Run #16, Run #17 versus Run #19, and Run #18 versus Run #20. In the aggregate, runs with packing exhibit better performance than runs without packing.

Comparison of Run #19 versus Run #21, as well as Run #20 versus #22 show that 3-mm quartz glass beads worked better than 1-mm glass beads. Further, comparison of Run #23 versus Run #25 and Run #29 versus Run #31 show that 6.4 mm stainless steel balls worked better than 4.8 mm stainless steel balls. This is because the surface area to volume ratio is greater for the larger beads, and the smaller beads pack more densely. Greater interstitial space allows more rapid draining of liquid-like carbon dioxide from the high-pressure density-driven separator. This demonstrates the surface area enhancement on high-pressure density-driven separator performance.

This invention covers packing materials designed on the macroscopic scale, the microscopic scale, and the nano-scale to enhance high-pressure density-driven separator performance. Spheres were chosen for proof-of-concept experimentation discussed above, and quartz glass and stainless steel were effective (both have high surface energy). The synergy between heat transfer surface area and surface energy effects (wetting and wicking) has also been established.

Macroscopic design of packing materials can induce cyclonic motion in a flowing stream. This expands the synergy of fluid state and surface effects to include hydrodynamic enhancement of high-pressure density-driven separator performance. FIG. 15B (left) shows an example of one such macroscopic design; spiralized cone packing.

The spiralized cone is a hollow structure with a thin wall. The pressurized gas mixture to be treated is introduced inside the spiralized cone tangentially and at high speed through a nozzle represented by the red arrow. The spiralized cone is made from a material with high surface energy, e.g., a metal. Metals also have high thermal conductivity, synergizing with fluid state enhancement of high-pressure density-driven separator performance. Liquid-like carbon dioxide wets the high-energy surface and rapidly drains. This is shown in FIG. 15B by the dashed lines on the spiralized cone. The other components of flue gas are less dense and are vented through the top, as shown by the dark arrows pointing down.

Microscopic design works with macroscopic design to deploy appropriately designed surface area in regions of high carbon dioxide concentration within the high-pressure density-driven separator and enable surface tension driven flow. An example of packing design on the microscopic scale to enhance high-pressure density-driven separator performance is illustrated in FIG. 15B (right). The angle formed by the metal in the outer edge of the circular channels of the hollow spiralized cone structure is acute and creates a microscopic wicking channel. Surface tension driven flow of carbon dioxide occurs around the cone and to exit ports.

Periodically along the spiral, a microscopic “port” (simply a microscopic hole). One is shown at the terminus of the lower wicking channel in FIG. 15B. This allows carbon dioxide to escape to the outside surface of the spiralized cone, where it flows down and off of the exterior of the packing structure and out of the high-pressure density-driven separator.

Nano-scale design works with macroscopic design and microscopic design to enhance high-pressure density-driven separator performance. An example of this is illustrated in FIG. 15B. The flow path of carbon dioxide out of a microscopic port on the spiralized cone and down the exterior of the packing is represented in FIG. 15B by the dashed lines on the spiralized cone. This vertical path will be etched on the nano-scale on the exterior surface (e.g., laser etching). This will maximize surface tension driven flow in the same direction as the gravitational field. Only the first port and path are shown. There will be many ports and many paths for gravity-driven and surface energy-driven flow down the exterior surface of the packing and out of the high-pressure density-driven separator.

The spiralizer cone structure is one example of packing designed on the macroscopic scale, the microscopic scale, and the nano-scale to enhance high-pressure density-driven separator performance and synergy amongst hydrodynamic effects, fluid state effects, and surface effects. Other structures and methods of exploiting synergistic aspects of high-pressure density-driven separator performance include but are not limited to fins (FIG. 15A, left), porous materials (FIG. 15A, right), and micro-fibrous metal mesh.

The high-energy surface area is deployed in carbon dioxide-rich zones created during hydrodynamic enhancement of high-pressure density-driven separator performance, as described above. Thermal contact with the heat transfer fluid is maintained in the high-surface energy surface area. In this manner, the dense, liquid-like carbon dioxide is preferentially cooled, relative to the aggregate vapor. Thus, aspects of high-pressure density-driven separator performance enhancement via deployment of high-energy surface area can be synergistic with hydrodynamic and thermal enhancement of high-pressure density-driven separator performance. Exploitation of this synergy has resulted in the performance improvement of about 2.5 orders of magnitude during experimentation documented in FIG. 10 and Table 5.

### Section II. Aspects of the HDS-Based Carbon Dioxide Capture Process

There are several areas for innovation in implementing an FIDS-based carbon dioxide capture process. First, aspects of implementation and operation of the high-pressure density-driven separator design concepts discussed above. Second, strategies for energy recovery and overall process efficiency. Third, strategies for the use and sequestration of the high-pressure carbon dioxide produced.

### II.1 Implementation of High-Pressure Density-Driven Separator Design Concepts

A 500 MW power plant serves over a million households. If it burns coal, it generates about 50 kg/s of carbon dioxide. The size of the high-pressure density-driven separator capable of achieving this rate of separation is a key issue. Based on our current value of our separation metric (VEₛₑₚ≈500×10⁻¹²), the required high-pressure density-driven separator would have a very large volume. As shown in FIG. 10 and Table 5, we have already increased VEₛₑₚ by 2.5 orders of magnitude. If a similar increase in performance during continued research and development, the volume of a high-pressure density-driven separator vessel for a 500 MW coal-burning power plant would be less than 150 m³, 2.5 m in diameter with an L/D of about 10. Full exploitation of the synergy of fluid state effects, hydrodynamic effects, and surface effects documented above may lead to performance that reduces this volume further.

The size of a commercial-scale high-pressure density-driven separator and safety considerations suggest two configurations; multiple separation vessels in parallel or one large vessel. In the latter case, underground installation has advantages. In this context, projected dimensions are quite attainable, as are reductions thereof. Moreover, the high-pressure density-driven separator can be directly coupled with deep well injection for geologic sequestration, as shown in FIG. 16. In this manner, it would be possible to construct a power plant with zero carbon dioxide discharge.

FIG. 1 shows a compressor/expander engine on the carbon dioxide separand stream. The compressor creates a carbon dioxide stream at 24 MPa. This is suitable for a variety of transport, sequestration and use strategies including enhanced oil recovery and geologic sequestration.

Another aspect of the present invention is a self-sealing plug for the high-pressure density-driven separator. One embodiment of this plug is shown in FIG. 17.

### II.2 Energy Recovery

FIG. 1A is another process flow diagram. To the left of the high-pressure density-driven separator module, it shows four compressors paired with four compressors. All have similar compression/expansion ratios (˜3). Each pair of compressors and expanders operates together as an engine. They exchange heat for intercooling and inter-heating. If the vapor feed contains 15% by mass carbon dioxide (e.g., flue gas from a coal-burning power plant), 85% of the vapor compressed can be expanded back to its original state and released to the environment. Further, moderate temperature heat transfer fluids, including process streams, ambient fluids, and/or fluids from other operations, can also be used to improve compression and expansion efficiencies. These configurations are explored through the application of thermodynamic principles (subject to attainable efficiencies) in detailed mass and energy balances. They form the bases for cost estimates. As discussed above, heat transfer fluids can also be used to increase carbon dioxide separation volumetric efficiency.

FIG. 18 provides cost estimates based on a thermodynamic model corresponding to FIG. 1. It is based on four stages of isentropic compression and expansion, with compression/expansion ratios of about 3. An efficiency of 90% is attainable by pairing compressors and expanders into engines that exchange heat for intercooling and inter-heating with technology currently available. This corresponds to an operating cost of about $18/metric ton of carbon dioxide removed, less than one-third current state of the art. This number is based on electrical input to the compressors. Operating cost is further reduced by powering the compressors with diesel fuel or natural gas. Further cost reductions will result from the use of external coolant and waste heat. The moderate temperatures of the high-pressure density-driven separator process render these heat transfer fluids nearly free, and their use increases efficiency and drives down operating costs. Examination of FIG. 18 reveals that operating costs are very low at 80% efficiency, as well (˜$23/metric ton carbon dioxide removed).

The high-pressure density-driven separator operates at high pressure, but relatively close to ambient temperature. Also, the consequences of a temporary drop in performance are not dire. Therefore, the high-pressure density-driven separator process can be shut down and started up easily. Pressure can be maintained with no flow. This lends itself to peak load balancing. The high-pressure density-driven separator process could be operated intermittently during periods of non-peak load.

FIG. 1B is a simplified process flow diagram showing two compressors with an intercooler, and one turbo expander. Since the HDS itself has no moving parts, the primary energy input for an HDS-based separation system is the work required for pressurization. The HDS then splits the high-pressure fluid into a dense CO₂ stream, and a light stream containing the other vapor species. As shown in Table 1, the flue gas from a coal-burning power plant contains about 79% N₂ and 5% O₂. Therefore, 84% of the gas compressed can be immediately expanded to recover the energy.

### II.3 Carbon Dioxide Sequestration and Use Strategies

The high-pressure density-driven separator produces very pure carbon dioxide at very high pressure. This condition facilitates sequestration and use strategies. Some of these were discussed above. Other strategies for use and sequestration are desirable. The high purity and high pressure of the carbon dioxide produced by the high-pressure density-driven separator process favors conversion to high-value solids and liquids (e.g., carbon nanomaterials and polymers). Equilibrium of reactions forming liquid products and solid products (e.g., carbonates) is product-favored by high pressure.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above processes and apparatus a without departing from the scope of the invention, it is intended that all matter contained in the above description and shown in the accompanying drawings shall be interpreted as illustrative and not in a limiting sense.

### REFERENCES

Espanani, R., Miller, A. and Jacoby, W. A. “Prediction of Vapor-Liquid Equilibria for Mixtures of Low Boiling Point Compounds Using Wong-Sandler Mixing rule and EOS/G^{EX} Model.” Chemical Engineering Science. Volume 152, 2 Oct. 2016, Pages 343-350
Espanani, R., Miller, A., Busick, A., Hendry, D., and Jacoby, W. “Separation of nitrogen/carbon dioxide Mixture Using A Continuous High-pressure Density-driven Separator.” Journal of CO₂ Utilization 14 (2016) 67-75
Miller, A., Espanani, R., Junker, A., Hendry, D., Wilkinson, N., Abelleira-Pereira, J., Deshusses, M. A., Inniss, E., and Jacoby, W. “Supercritical Oxidation of Simulated Feces without the Use of a Co-fuel.” Chemosphere. Volume 141, December 2015, Pages 189-196.
Hendry, D., Miller, A., Wilkinson, N., Wickramathilaka, M., Espanani, R. and Jacoby, W. A. “Exploration of High Pressure Separations of Nitrogen and Carbon Dioxide.” Journal of CO₂ Utilization 3-4 (2013) 37-43.
Wilkinson, N., Hendry, D., Venkitasamy, C. and Jacoby, W. A. “Study of process variables in supercritical carbon dioxide extraction of soybeans.” Food Science and Technology International 20(1) (2013), 63-70.
Wilkinson, N., Wickramathilaka, M., Hendry, D., Miller, A., Espanani, R., and Jacoby, W. A. “Rate determination of supercritical water gasification of primary sewage sludge as a replacement for anaerobic digestion.” Bioresource Technology, 124 (2012) 269-275
Miller, A., Hendry, D., Jacoby, W. A. “Gasification of Algae in Supercritical Water to Produce High-value Fuel Gas.” Bioresource Technology, 119 (2012) 41-47.
Hendry, D., Miller, A., Jacoby, W. A. “Turbulent Operation of a Plug Flow Reactor for Gasification of Alcohols in Supercritical Water.” Industrial Engineering & Chemistry Research, 2012, 51, 2578-2585.
Venkitasamy, C., Hendry, D., Wilkinson, N., Fernando, L. and Jacoby, W. A. “Investigation of thermochemical conversion of biomass in supercritical water using a batch reactor.” Fuel 90 (2011), pp. 2662-2670.
Hendry, D., Venkitasamy, C. Wilkinson, N. and Jacoby, W. A. “Exploration of the effect of process variables on the production of high-value fuel gas from glucose via supercritical water gasification” Bioresource Technology 102 (2011) 3480-3487.

What is claimed is:

1. A process for the capture of carbon dioxide, the process comprising:
compressing a vapor comprising carbon dioxide and at least one other component to form a compressed mixture comprising a dense carbon dioxide fluid and the at least one other component;
feeding the compressed mixture comprising the dense carbon dioxide fluid and the other components to a high-pressure density-driven separator wherein a stream enriched in the dense carbon dioxide fluid and a stream enriched in the at least one other component are formed;
removing the stream enriched in the dense carbon dioxide fluid from the separator; and
removing the stream enriched in the at least one other component from the separator.

2. The process of claim 1 wherein the thermodynamic state (pressure, temperature, and composition) of the vapor provides for a substantially complete separation of the carbon dioxide from the at least one other component.

3. The process of claim 1 or 2 wherein the vapor is compressed to a pressure of at least about 4 MPa, at least about 8 MPa, at least about 10 MPa, at least about 12 MPa, or at least about 15 MPa.

4. The process of any one of claims 1 to 3 wherein the temperature of the compressed mixture that is fed to the high-pressure density-driven separator is at least or about 25° C., at least or about 10° C., at least or about 0° C., or at least or about −10° C.

5. The process of any one of claims 1 to 3 wherein the temperature of the compressed mixture that is fed to the high-pressure density-driven separator is from about −10° C. to about 40° C., from about −10° C. to about 30° C., from about −10° C. to about 25° C., from about 0° C. to about 40° C., from about 0° C. to about 30° C., from about 0° C. to about 25° C., from about 10° C. to about 40° C., or from about 10° C. to about 30° C.

6. The process of any one of claims 1 to 5 wherein the vapor has a carbon dioxide concentration of at least about 1%, at least about 5%, or at least about 10% by volume.

7. The process of any one of claims 1 to 5 wherein the vapor has a carbon dioxide concentration of from about 1% to about 25%, from about 5% to about 25%, from about 10% to about 25%, from about 1% to about 50%, from about 5% to about 50%, or from about 10% to about 50% by volume.

8. The process of any one of claims 1 to 7 wherein the at least one other component is selected from the group consisting of nitrogen, oxygen, methane, hydrogen, ethane, propane, carbon monoxide, water, sulfur dioxide, nitrogen dioxide, and mixtures thereof.

9. The process of any one of claims 2 to 8 wherein the vapor comprises at least two, three, four, or five other components selected from the group consisting of nitrogen, oxygen, methane, hydrogen, ethane, propane, carbon monoxide, water, sulfur dioxide, nitrogen dioxide, and mixtures thereof.

10. The process of claim 1 wherein the vapor comprises at least two, three, four, or five other components selected from the group consisting of nitrogen, oxygen, methane, hydrogen, ethane, propane, carbon monoxide, water, sulfur dioxide, nitrogen dioxide, and mixtures thereof.

11. The process of any one of claims 2 to 10 wherein the at least one other component comprises nitrogen.

12. The process of claim 1 wherein the at least one other component comprises nitrogen.

13. The process of claim 11 or 12 wherein the vapor has a nitrogen concentration of at least about 50%, at least about 60%, at least about 70%, or at least about 80% by volume.

14. The process of claim 11 or 12 wherein the vapor has a nitrogen concentration of from about 50% to about 90%, from about 50% to about 85%, from about 50% to about 80%, from about 50% to about 70%, from about 60% to about 90%, from about 60% to about 85%, from about 60% to about 80%, from about 60% to about 70%, from about 70% to about 90%, from about 70% to about 85%, from about 70% to about 80%, from about 80% to about 90%, from about 80% to about 85% or from about 85% to about 90% by volume.

15. The process of any one of claims 1 to 14 wherein the vapor comprises flue gas produced from the combustion of a carbonaceous fuel.

16. The process of any one of claims 1 to 15 wherein the vapor comprises a fuel gas selected from the group consisting of natural gas, shale gas, town gas, producer gas, and biogas.

17. The process of any one of claims 1 to 16 wherein the dense carbon dioxide fluid has a density that is at least about 0.5 g/cm³ or at least about 0.7 g/cm³ greater than the other components of the gas.

18. The process of any one of claims 1 to 17 wherein the compressed mixture is subjected to a cyclonic fluid motion in the high-pressure density-driven separator to enhance the rate of separation of the carbon dioxide from the at least one other component.

19. The process of any one of claims 2 to 18 wherein the high-pressure density-driven separator comprises a vessel, a feed inlet for introducing the compressed mixture to the vessel, a first outlet for removing the stream enriched in dense carbon dioxide fluid from the vessel, and a second outlet for removing the stream enriched in the at least one other component from the vessel.

20. The process of claim 1 wherein the high-pressure density-driven separator comprises a vessel, a feed inlet for introducing the compressed mixture to the vessel, a first outlet for removing the stream enriched in dense carbon dioxide fluid from the vessel, and a second outlet for removing the stream enriched in the at least one other component from the vessel.

21. The process of claim 19 wherein the feed inlet comprises a nozzle configured to induce cyclonic fluid motion.

22. The process of claim 20 wherein the feed inlet comprises a nozzle configured to induce cyclonic fluid motion.

23. The process of claim 21 or 22 wherein the nozzle has an orientation that is tangential or approximately normal to the direction of fluid flow in the vessel of the high-pressure density-driven separator.

24. The process of any one of claims 1 to 23 wherein the vessel of the high-pressure density-driven separator comprises surface internals to induce cyclonic fluid motion.

25. The process of claim 24 wherein the surface internals comprise structures of a macroscopic scale, a microscopic scale, and/or nano-scale.

26. The process of claim 24 or 25 wherein the surface internals comprise fins, a porous packing material, and/or a series of capillaries.

27. The process of any one of claims 24 to 26 wherein the surface internals further facilitate the formation of liquid-like carbon dioxide and its surface tension-driven flow.

28. The process of any one of claims 2 to 27 wherein the high-pressure density-driven separator further comprises a spiralized conical packing.

29. The process of claim 1 wherein the high-pressure density-driven separator further comprises a spiralized conical packing.

30. The process of any one of claims 1 to 29 further comprising cooling of the high-pressure density-driven separator vessel and the fluids and surfaces therein.

31. The process of any one of claims 1 to 30 wherein the high-pressure density-driven separator further comprises a heat exchanger comprising a tube for flow of a heat transfer fluid.

32. The process of any one of claims 19 to 31 wherein the vessel of the high-pressure density-driven separator comprises a heat exchanger in a tube-in-tube configuration wherein the vessel forms an outer tube and a heat transfer fluid flows through an inner tube.

33. The process of any one of claims 19 to 32 wherein the vessel of the high-pressure density-driven separator comprises a heat exchanger in a tube-in-tube configuration wherein the vessel forms an inner tube and a heat transfer fluid flows through an outer tube.

34. The process of any one of claims 19 to 33 wherein the vessel of the high-pressure density-driven separator comprises a heat exchanger in a tube-in-shell configuration wherein the vessel forms a shell and a heat transfer fluid flows through a series of enclosed tubes.

35. The process of any one of claims 31 to 34 wherein the flow of the heat transfer fluid is such that carbon dioxide is preferentially cooled relative to the other component(s) of the vapor.

36. The process of claims 31 to 35 further comprising recirculating at least a portion of the dense carbon dioxide fluid removed from the high-pressure density-driven separator as a heat transfer fluid to a tube the heat exchanger.

37. The process of claim 36 wherein the dense carbon dioxide fluid that is recirculated undergoes a change of state via heat transfer to the separator and any surface internals therein.

38. The process of any one of claims 1 to 37 further comprising expanding or heating at least a portion of the dense carbon dioxide fluid removed from the high-pressure density-driven separator such that the dense carbon dioxide fluid undergoes a change in state.

39. The process of any one of claims 1 to 38 wherein the dense carbon dioxide fluid undergoes a change in state in an engine or device external to the high-pressure density-driven separator.

40. The process of any one of claims 1 to 39 wherein the process is a continuous process.

41. The process of any one of claims 1 to 40 wherein the vapor comprises hydrogen and hydrogen is separated from the at least one other component.

42. The process of any one of claims 1 to 41 wherein the stream enriched in the dense carbon dioxide fluid from the separator comprises at least about 70%, at least about 80%, at least about 90%, at least about 95%, or at least about 99% of the carbon dioxide content of the compressed mixture fed to the high-pressure density-driven separator.

43. The process of any one of claims 1 to 41 wherein the stream enriched in the dense carbon dioxide fluid from the separator comprises from about 70% to about 100%, from about 70% to about 99%, from about 70% to about 95%, from about 70% to about 90%, from about 80% to about 100%, from about 80% to about 99%, from about 80% to about 95%, from about 80% to about 90%, from about 90% to about 100%, from about 90% to about 99%, from about 90% to about 95%, from about 95% to about 100% of the carbon dioxide content of the compressed mixture fed to the high-pressure density-driven separator.

44. The process of any one of claims 1 to 43 wherein the stream enriched in the at least one other component from the separator comprises at least about 70%, at least about 80%, at least about 90%, at least about 95%, or at least about 99% of the at least one other component content of the compressed mixture fed to the high-pressure density-driven separator.

45. The process of any one of claims 1 to 44 wherein the stream enriched in the at least one other component from the separator comprises from about 70% to about 100%, from about 70% to about 99%, from about 70% to about 95%, from about 70% to about 90%, from about 80% to about 100%, from about 80% to about 99%, from about 80% to about 95%, from about 80% to about 90%, from about 90% to about 100%, from about 90% to about 99%, from about 90% to about 95%, from about 95% to about 100% of the at least one other component content of the compressed mixture fed to the high-pressure density-driven separator.

46. An apparatus for separating a vapor comprising two or more components comprising:
(a) one or more compressors comprising an inlet for introducing a vapor to the compressor and an outlet for removing a compressed fluid;
(b) a high-pressure density-driven separator comprising a vessel, a feed inlet for introducing the compressed fluid to the vessel, a first outlet for removing a stream enriched in a dense fluid from the vessel, and a second outlet for removing the stream enriched a less dense fluid from the vessel, and wherein the feed inlet of the high-pressure density-driven separator is in fluid communication with the outlet of the compressor; and
(c) one or more expanders is in fluid communication with the first outlet and/or second outlet of the high-pressure density-driven separator.

47. The apparatus of claim 46 wherein the apparatus comprises a plurality of compressors in series paired with a plurality of expanders is series in an engine configuration and wherein the plurality of compressors comprises the inlet for introducing a vapor to the compressor and the outlet for removing a compressed fluid and the plurality of expanders comprises an inlet in fluid communication with the second outlet of the high-pressure density-driven separator and an outlet for discharging an expanded fluid.

48. The apparatus of claim 46 or 47 wherein the vessel of the high-pressure density-driven separator comprises surface internals.

49. The apparatus of claim 48 wherein the surface internals comprise fins, a porous packing material, and/or a series of capillaries.

50. The apparatus of claim 48 or 49 wherein the surface internals are configured to induce cyclonic fluid motion.

51. The apparatus of any one of claims 47 to 50 wherein the high-pressure density-driven separator further comprises a spiralized conical packing.

52. The apparatus of claim 46 wherein the high-pressure density-driven separator further comprises a spiralized conical packing.

53. The apparatus of any one of claims 47 to 52 wherein the feed inlet comprises a nozzle configured to induce cyclonic fluid motion.

54. The apparatus of any one of claims 47 to 53 wherein the feed inlet comprises a nozzle configured to induce cyclonic fluid motion.

55. The apparatus of claim 46 wherein the feed inlet comprises a nozzle configured to induce cyclonic fluid motion.

56. The apparatus of claim 54 or 55 wherein the nozzle has an orientation that is tangential or approximately normal to the direction of fluid flow in the vessel of the high-pressure density-driven separator.

57. The apparatus of any one of claims 46 to 56 wherein the high-pressure density-driven separator further comprises a heat exchanger comprising a tube for flow of a heat transfer fluid.

58. The apparatus of any one of claims 46 to 57 wherein the vessel of the high-pressure density-driven separator comprises a heat exchanger in a tube-in-tube configuration wherein the vessel forms an outer tube and a heat transfer fluid flows through an inner tube.

59. The apparatus of any one of claims 46 to 58 wherein the vessel of the high-pressure density-driven separator comprises a heat exchanger in a tube-in-tube configuration wherein the vessel forms an inner tube and a heat transfer fluid flows through an outer tube.

60. The apparatus of any one of claims 46 to 59 wherein the vessel of the high-pressure density-driven separator comprises a heat exchanger in a tube-in-shell configuration wherein the vessel forms a shell and a heat transfer fluid flows through a series of enclosed tubes.

61. The apparatus of any one of claims 46 to 60 wherein the high-pressure density-driven separator further comprises a second inlet, one or more expanders is in fluid communication with the first outlet of the high-pressure density-driven separator, and the expander comprises an outlet that this in fluid communication with the second inlet of the high-pressure density-driven separator.

62. The apparatus of any one of claims 46 to 61 wherein at least a portion of the apparatus is positioned underground.

63. The apparatus of any one of claims 46 to 62 further comprising an underground well in fluid communication with the first outlet and/or second outlet of the high-pressure density-driven separator.

64. The apparatus of claim 63 wherein the underground well comprises a self-sealing cap which is configured to be open at low pressure and sealed at high pressure.

65. A process for separating a vapor comprising a first component and a second component, the process comprising:
compressing the vapor to form a compressed mixture wherein the first component has a density that is greater than the density of the second component;
feeding the compressed mixture to a high-pressure density-driven separator wherein a stream enriched in the first component and a stream enriched in the second component are formed;
removing the stream enriched in the first component from the separator; and
removing the stream enriched in the second component from the separator.

66. The process of claim 65 wherein the vapor is compressed to a pressure in which the density of the first component is at least about 5 times, at least about 10 times, at least about 20 times greater than the density of the second component.

67. The process of claim 65 or 66 wherein the first component comprises at least one, two, three, four or five components selected from the group consisting of carbon dioxide, nitrogen, oxygen, methane, ethane, propane, carbon monoxide, water, sulfur dioxide, nitrogen dioxide, and mixtures thereof.

68. The process of claim 66 or 67 wherein the second component comprises hydrogen.

69. The process of claim 65 wherein the second component comprises hydrogen.

70. The process of any one of claims 65 to 69 wherein the compressed mixture is subjected to a cyclonic fluid motion in the high-pressure density-driven separator to enhance the rate of separation of the first component from the second component.

71. The process of any one of claims 65 to 70 wherein the high-pressure density-driven separator comprises a vessel, a feed inlet for introducing the compressed mixture to the vessel, a first outlet for removing the stream enriched in dense carbon dioxide fluid from the vessel, and a second outlet for removing the stream enriched in the at least one other component from the vessel.

72. The process of claim 71 wherein the feed inlet comprises a nozzle configured to induce cyclonic fluid motion.

73. The process of claim 72 wherein the nozzle, wherein the port has an orientation that is tangential or approximately normal to the direction of fluid flow in the vessel of the high-pressure density-driven separator.

74. The process of any one of claims 65 to 73 wherein the vessel of the high-pressure density-driven separator comprises surface internals to induce cyclonic fluid motion.

75. The process any one of claims 65 to 74 wherein the high-pressure density-driven separator further comprises a spiralized conical packing.

76. The process of any one of claims 65 to 75 wherein the stream enriched in the first component from the separator comprises at least about 70%, at least about 80%, at least about 90%, at least about 95%, or at least about 99% of the first component content of the compressed mixture fed to the high-pressure density-driven separator.

77. The process of any one of claims 65 to 76 wherein the stream enriched in the first component from the separator comprises from about 70% to about 100%, from about 70% to about 99%, from about 70% to about 95%, from about 70% to about 90%, from about 80% to about 100%, from about 80% to about 99%, from about 80% to about 95%, from about 80% to about 90%, from about 90% to about 100%, from about 90% to about 99%, from about 90% to about 95%, from about 95% to about 100% of the first component content of the compressed mixture fed to the high-pressure density-driven separator.

78. The process of any one of claims 65 to 77 wherein the stream enriched in the second component from the separator comprises at least about 70%, at least about 80%, at least about 90%, at least about 95%, or at least about 99% of the second component content of the compressed mixture fed to the high-pressure density-driven separator.

79. The process of any one of claims 65 to 77 wherein the stream enriched in the second component from the separator comprises from about 70% to about 100%, from about 70% to about 99%, from about 70% to about 95%, from about 70% to about 90%, from about 80% to about 100%, from about 80% to about 99%, from about 80% to about 95%, from about 80% to about 90%, from about 90% to about 100%, from about 90% to about 99%, from about 90% to about 95%, from about 95% to about 100% of the second component content of the compressed mixture fed to the high-pressure density-driven separator.
